(19) United States
(12) Patent Application Publication
(10) Pub. No.: US 2025/0097581 A1
(43) Pub. Date: Mar. 20, 2025

(54) IMAGING SYSTEM AND MOBILE OBJECT PROVIDED WITH SAME

(71) Applicant: Panasonic Intellectual Property Management Co., Ltd., Osaka (JP)

(72) Inventors: Satoshi MATSUI, Kyoto (JP); Norikazu KATSUYAMA, Osaka (JP)

(21) Appl. No.: 18/961,954

(22) Filed: Nov. 27, 2024

Related U.S. Application Data
(63) Continuation of application No. PCT/JP2023/020299, filed on May 31, 2023.

(30) Foreign Application Priority Data
Jun. 1, 2022 (JP) 2022-089866

(51) Int. Cl. H04N 23/695; G03B 5/06; G03B 30/00; H04N 23/667; H04N 23/68

(52) U.S. Cl. CPC H04N 23/695; G03B 5/06; G03B 30/00; H04N 23/667; H04N 23/6812; H04N 23/685

(57) ABSTRACT

An optical axis changing assembly changes an optical axis of an imaging device to states of k optical axes, so that the optical axis of the imaging device changes from a state of a first optical axis of the imaging device during capturing a first image to a state of a second optical axis displaced in a second direction intersecting a first direction during capturing a second image, to sequentially change the optical axis of the imaging device in a second direction. The imaging device is installed with an installation inclination so that a predetermined optical axis among the k optical axes is inclined at a predetermined angle smaller than an optical axis change angle of the optical axis changing assembly with respect to a direction from an installation position of the imaging device to an imaging target region in a plane including the k optical axes.

### CROSS-REFERENCE TO RELATED APPLICATIONS

This is a continuation application of International Application No. PCT/JP2023/020299, with an international filing date of May 31, 2023, which claims priority of Japanese Patent Application No. 2022-089866 filed on Jun. 1, 2022, the content of which is incorporated herein by reference.

### BACKGROUND

### Technical Field

The present disclosure relates to an imaging system that is fixed to a mobile object and performs imaging while the mobile object is moving, and the mobile object provided with the imaging system.

### Background Art

With the aging of transportation infrastructure, the demand for infrastructure inspection is increasing. The inspection efficiency is remarkably improved by imaging the infrastructure facility during movement with a mobile object and detecting a defective portion on the captured image with image processing instead of the visual inspection by a person.

For example, in WO 2015/060181 A, a camera installed in a vehicle captures an image of a target region during moving. Further, in a case where the traveling speed of the vehicle is high, a blur due to camera movement occurs, but in WO 2015/060181 A, the blur due to movement is corrected using a technique of a saccade mirror. The blur is reduced by irradiating an imaging target with light, by reflecting the light reflected from the imaging target from a mirror, and by injecting the light to the camera. The mirror rotates for a predetermined exposure time.

### SUMMARY

However, in a case where a high-resolution image is captured, a lens having a long focal length is used, and thus, the angle of view becomes small. This makes the imaging range narrow.

The present disclosure provides an imaging system capable of expanding the imaging range, and a mobile object having the imaging system.

An imaging system of the present disclosure includes an imaging device disposed in a mobile object, an optical axis changing assembly that, when the imaging device performs imaging while the mobile object is moving in a first direction, changes an optical axis of the imaging device to states of k optical axes, k being an integer of two or more, so that the optical axis of the imaging device changes from a state of a first optical axis of the imaging device during capturing a first imaging to a state of a second optical axis displaced in a second direction intersecting the first direction during capturing a second image, to sequentially change the optical axis of the imaging device in the second direction, and a controller that operates the optical axis changing assembly. The imaging device is installed with an installation inclination so that a predetermined optical axis among the k optical axes is inclined at a predetermined angle smaller than an optical axis change angle of the optical axis changing assembly with respect to a direction from an installation position of the imaging device to an imaging target region in a plane including the k optical axes.

Further, the mobile object of the present disclosure includes the above-described imaging system.

According to the imaging system and the mobile object having the same of the present disclosure, it is possible to provide the imaging system capable of expanding an imaging range and the mobile object having the same.

### BRIEF DESCRIPTION OF DRAWINGS

FIG. 1 is a diagram for explaining a vehicle including an imaging system according to a first embodiment.

FIG. 2 is a block diagram illustrating an internal configuration of the imaging system according to the first embodiment.

FIGS. 3A and 3B are explanatory diagrams for explaining states of an imaging device in states of two optical axes.

FIG. 4 is an explanatory diagram illustrating an image captured in a first imaging mode.

FIG. 5 is an explanatory diagram illustrating an image captured in a second imaging mode.

FIGS. 6A and 6B are explanatory diagrams for explaining imaging expansion range with the imaging device in states of two optical axes.

FIG. 7 is a flowchart illustrating imaging processing in the first embodiment.

FIG. 8A-8C are graphs illustrating a relationship between a change in a moving speed, a timing of an exposure time, and a change of an optical axis in the first embodiment.

FIG. 9 is a diagram illustrating a modification of an imaging mode.

FIG. 10 is a diagram illustrating a modification of the imaging mode.

FIG. 11 is an explanatory diagram for explaining the imaging expansion range with the imaging device in states of two optical axes in a second embodiment.

FIG. 12A is a diagram for explaining a vehicle including an imaging system according to a third embodiment.

FIGS. 12B and 12C are explanatory diagrams for explaining states of the imaging device in respective states of two optical axes in the third embodiment.

FIG. 13 is a block diagram illustrating an internal configuration of the imaging system according to the third embodiment.

FIG. 14 is an explanatory diagram for explaining blur correction of the imaging system.

FIG. 15 is a flowchart illustrating imaging processing in the third embodiment.

FIG. 16A-16D are graphs illustrating a relationship between a change in a moving speed, a timing of an exposure time, and an optical axis change in the third embodiment.

FIG. 17 is a block diagram illustrating an internal configuration of an imaging system according to a fourth embodiment.

FIG. 18 is a flowchart illustrating imaging processing in the fourth embodiment.

FIG. 19 is a block diagram illustrating an internal configuration of the imaging system according to the fourth embodiment.

FIG. 20 is a flowchart illustrating imaging processing in a fifth embodiment.

FIG. 21 is a flowchart illustrating imaging processing in a modification of the fifth embodiment.

### DETAILED DESCRIPTION

### First Embodiment

A first embodiment will be described below with reference to the drawings. The first embodiment describes a case where the mobile object is a vehicle 3 such as an automobile and an imaging system 1 is attached to an upper portion of the vehicle 3 as an example. The imaging system 1 of the first embodiment is disposed to image a road as an example.

### [1-1. Configuration of Imaging System]

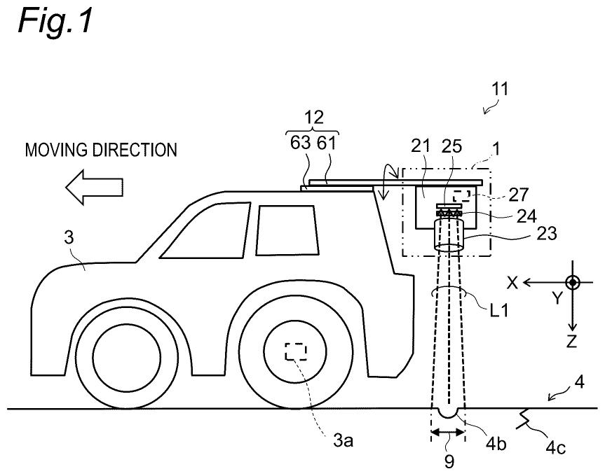

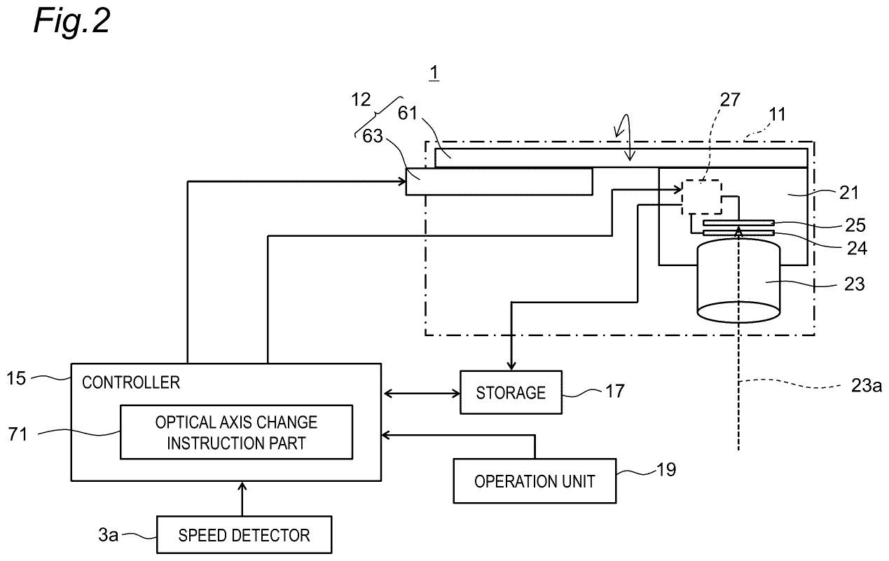

FIGS. 1 and 2 are referred to. FIG. 1 is a diagram for explaining the imaging system 1. FIG. 2 is a block diagram illustrating an internal configuration of the imaging system 1. In FIG. 1, the vehicle 3 is traveling on a road 4, for example. For example, a hole 4b or a crack 4c occurs on the road 4. In addition, a pot hole, a rut, or the like that occurs on the road surface can be detected in a captured image with image processing.

An imaging target of the imaging system 1 is at least a part of a structure around the vehicle 3, and is a target that relatively moves in accordance with a moving speed of the vehicle 3 when the vehicle 3 moves. An imaging target region 9 is a region acquired as an image in the imaging target. The imaging target may include, in addition to the road 4, an inner wall of a tunnel, a side surface or a bottom surface of a bridge, a utility pole, or an electric wire. This makes it possible to detect, in the acquired image, a hole, a crack, lifting, peeling, and a joint of the imaging target, an inclination of a utility pole, and deflection of an electric wire with the image processing.

The imaging system 1 is installed on an upper surface of the vehicle 3. The imaging system 1 is fixed to capture an image of the road 4 below the vehicle 3 in FIG. 1.

As illustrated in FIGS. 1 and 2, the imaging system 1 includes a speed detector 3a, an imaging device 11, an optical axis changing assembly 12, and a controller 15. The imaging device 11 captures an image of a periphery of the vehicle 3, and images the road surface of the road 4 in the first embodiment. The imaging device 11 includes a camera body 21, a lens 23, a shutter 24, an imaging element 25, and a camera controller 27.

The speed detector 3a, which is disposed in the vehicle 3, detects the moving speed of the vehicle 3. This makes it possible to further detect that the vehicle 3 is moving. In the first embodiment, the speed detector 3a detects the moving speed based on a vehicle speed pulse signal. The vehicle speed pulse signal is switched to ON or OFF at each constant rotation amount (rotation angle) of the axle of the vehicle 3. The speed detector 3a transmits the vehicle speed pulse signal as well as the detected moving speed to the controller 15. In addition to this type of the detector, the speed detector 3a may be, for example, a vehicle speed sensor that detects the moving speed based on the rotation speed of the axle of the vehicle 3. The controller 15 may detect the moving speed based on the vehicle speed pulse signal.

The lens 23 is attached to the camera body 21 to be replaceable. The camera body 21 accommodates the imaging element 25 and the camera controller 27. The imaging element 25 is disposed at a position of a focal length F of the lens 23. The direction of the lens 23 directly faces the road 4 that is a subject. The camera body 21 and the lens 23 may be integrated. The imaging element 25 converts received light into an electric signal depending on intensity. The imaging element is a solid-state imaging element, such as a charge-coupled device (CCD) image sensor, a complementary metal oxide semiconductor (CMOS) image sensor, or an infrared image sensor.

The camera controller 27 opens the shutter 24 while receiving an exposure instruction signal from the controller 15. The shutter 24 may be configured to open and close a plurality of blade diaphragms, or may be an electronic shutter. The camera body 21 is supported to a base 61. The base 61 is rotatably supported on the upper surface of the vehicle 3.

When the imaging device 11 performs imaging while the vehicle 3 is moving in a first direction that is a +X-axis direction, the optical axis changing assembly 12 changes the optical axis of the lens 23 in the lens 23 of the imaging device 11. At this time, the optical axis changes from a state of a first optical axis 23ab directed perpendicularly to the road 4 at a time of capturing a first image to a state of a second optical axis 23ac inclined in a second direction that is a +Y-axis direction intersecting the first direction at a time of capturing a second image. The optical axis changing assembly 12 includes the base 61 and a rotation drive 63. The optical axis changing assembly 12 rotate an optical path to change the optical axis. Alternatively, the optical axis changing assembly 12 may rotate the imaging device 11 with a point different from a principal point 23b of the lens 23 being a rotation center, or may translate the imaging device 11.

The base 61 supports the camera body 21. Note that the imaging device 11 may be configured so that the camera body 21, the lens 23, and the optical axis changing assembly 12 are integrated. For example, the imaging device 11 may have a panning function of rotating the camera body 21 and the lens 23 in a lateral direction.

The rotation drive 63 rotationally drives the base 61 based on a rotation instruction from the controller 15. The rotation drive 63 includes, for example, a motor and a gear. As the base 61 rotates, the camera body 21 and the mirror 41 rotate. The optical axis changing assembly 12 may include, for example, a rotation stage, and may rotate the imaging device 11 with the rotation stage.

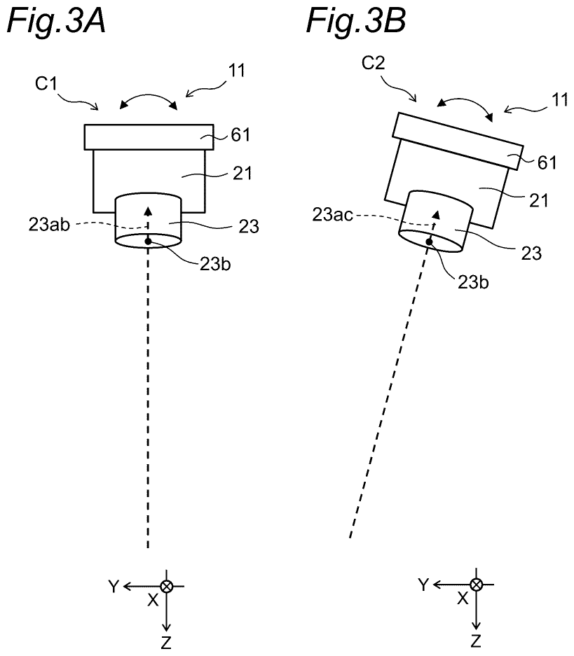

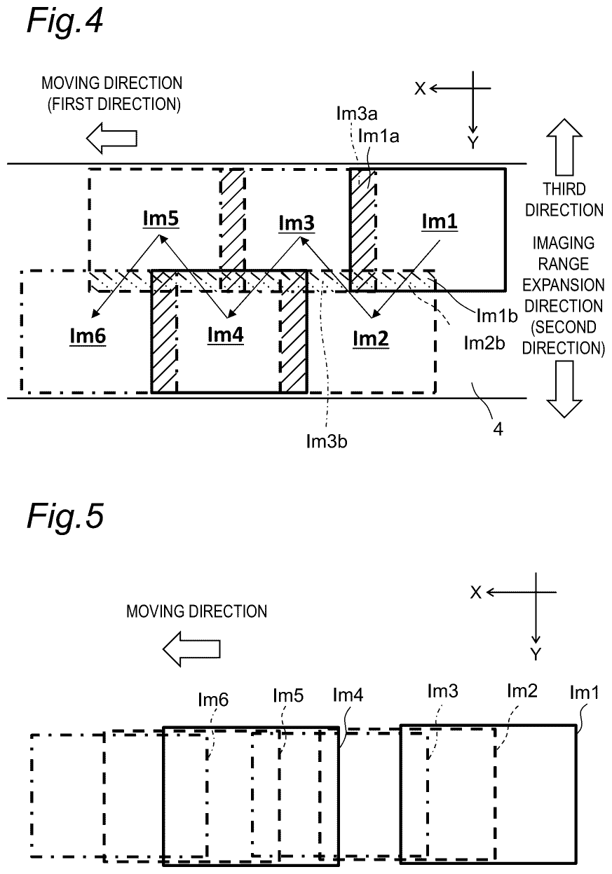

FIGS. 3A and 3B are referred to. FIGS. 3A and 3B are explanatory diagrams for explaining the imaging device 11 in states of two types of optical axes. FIG. 3A is the explanatory diagram illustrating the imaging device 11 in a first state C1 where the lens 23 is in the state of the first optical axis 23ab. FIG. 3B is the explanatory diagram illustrating the imaging device 11 in a second state C2 where the lens 23 is in the state of the second optical axis 23ac. The imaging device 11 can be displaced between the first state C1 illustrated in FIG. 3A and the second state C2 illustrated in FIG. 3B by driving the rotation drive 63. The optical axis changing assembly 12 rotates the imaging device 11 about the principal point 23b of the lens 23 as a rotation center, for example. This makes, as illustrated in FIG. 4, it possible to expand the imaging range of the imaging device 11 in the second direction.

For example, when the imaging device 11 is in the first state C1, a first image Im1 (see FIG. 4) is captured. After completion of capturing the image Im1, the imaging device 11 is displaced to the second state C2 and captures an image Im2. After the image Im2 is captured, an optical axis 23a of the lens 23 is displaced in a third direction that is the −Y-axis direction, namely, to the state of the first optical axis 23ab. As a result, the imaging device 11 is displaced to the first state C1 and captures an image Im3. As described above, the imaging device 11 images the road 4 while being alternately displaced between the first state C1 and the second state C2. In this way, the imaging device 11 captures a fourth image Im4, a fifth image Im5, and a sixth image Im6. This makes it possible to image a wider range of the road 4 in the second direction. A mode in which the imaging device 11 is displaced to perform imaging in this manner is referred to as a first imaging mode.

In the first imaging mode, an end region Im3a on the opposite side to the moving direction in the third captured image Im3 is imaged so as to overlap with an end region Im1a in the moving direction in the first captured image Im1. Imaging is performed so that an end region Im1b in the second direction (+Y-axis direction) in the first captured image Im1 overlaps with an end region Im2b in the third direction (−Y-axis direction) in the second captured image Im2. Further, imaging is performed so that an end region Im2b in the third direction (−Y-axis direction) in the second captured image Im2 overlaps with an end region Im3b in the second direction (+Y-axis direction) in the third captured image Im3. As described above, the first captured image Im1 and the third captured image Im3 have the common imaging region. Further, the first captured image Im1, the second captured image Im2, and the third captured image Im3 each have the common imaging region. Similarly, by sequentially capturing the images Im4, Im5, and Im6, these images have imaging regions overlapping each other in adjacent images. Further, the road 4 may be imaged without any gaps in adjacent images. In either case, imaging omission between images can be prevented.

The imaging system 1 may have a second imaging mode in which the images Im1 to Im6 are captured while the first state C1 is being maintained without displacing the imaging device 11. In this case, as illustrated in FIG. 5, captured images can be continuously acquired in a line. In FIG. 5, the widths of the images Im1 to Im6 in the Y-axis direction are different for easy understanding, but the actual widths are the same. Further, in the second imaging mode, for example, the imaging region of the image Im2 is entirely included in the imaging regions of the image Im1 and the image Im3. Therefore, the image Im2 does not have to be captured. That is, the imaging may be performed by skipping one image, like the images Im1, Im3, and Im5.

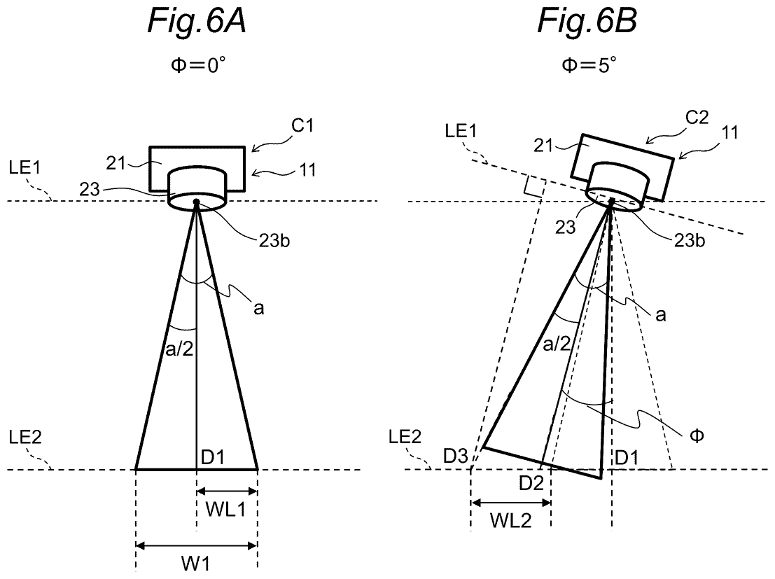

The expansion amount of the imaging range in the first imaging mode will be described with reference to FIGS. 6A and 6B. FIGS. 6A and 6B are explanatory diagrams for explaining the expansion amount of the imaging range. FIG. 6A is the explanatory diagram illustrating a state before a change of the optical axis (Φ=0°). FIG. 6B is the explanatory diagram illustrating a state after the change of the optical axis (Φ=5°). In FIGS. 6A and 6B, a distance between an extension line LE1 (extension line of an imaging plane) of the principal point 23b of the lens 23 and an extension line LE2 of the imaging target surface will be described for easy understanding of the description. In the first embodiment, the imaging target surface is the surface of the road 4.

It is assuming that the lateral size of the imaging element 25 is 7.03 [mm], the focal length F of the lens 23 is 35 [mm], and a first subject distance D1, which is the distance to the road 4 in a case where the optical axis of the imaging device 11 is at an initial position (optical axis change angle Φ=0), is 1.7 [m]. At this time, the angle of view a is 11.47 [deg], and a lateral imaging range W1 (=2×WL1) is 0.34 [m]. The lateral imaging range W1 is calculated according to the following Equation (1).

$$W 1 = 2 \times WL 1 = 2 \times D 1 \times tan ( a / 2 ) \qquad Equation ( 1 )$$

An expansion amount WL2 is calculated using the optical axis change angle Φ according to the following Equation (2). The optical axis change angle Φ is an angle through which the optical axis is rotated from the first optical axis 23ab by changing the optical axis.

$$WL 2 = D 1 \times tan \{ ( Φ + ( a / 2 ) \} - D 1 \times tan ( a / 2 ) \qquad Equation ( 2 )$$

In a case where the optical axis change angle Φ is 5 [deg], the expansion amount WL2 is 0.15 [m], and the imaging range is expanded by about 44% in the lateral direction.

Here, the optical axis change angle Φ≤the angle of view a. As a result, the image captured in the state of the first optical axis 23ab and the image captured in the state of the second optical axis 23ac may be continuous without a gap or may have an overlapping region. The optical axis change angle Φ may be a predetermined angle designated by a user using an operation unit 19, or may be determined by the controller 15 based on the distance to the imaging target region 9 and the angle of view a of the imaging device 11.

FIG. 2 is referred to. The controller 15 controls the exposure time of the imaging device 11 and the driving of the optical axis changing assembly 12, and operates the optical axis changing assembly 12 between a timing of capturing the first image and a timing of capturing the second image. The controller 15 is a circuit that can be implemented by a semiconductor element or the like. The controller 15 may include, for example, a microcomputer, a central processing unit (CPU), a microprocessor unit (MPU), a graphic processing unit (GPU), a digital signal processor (DSP), a field programmable gate array (FPGA), or an application-specific integrated circuit (ASIC). The function of the controller 15 may be configured by hardware alone, or may be achieved by combining hardware and software. The controller 15 reads data and programs stored in a storage 17 and performs various arithmetic processing to implement a predetermined function.

The controller 15 includes an optical axis change instruction part 71. The optical axis change instruction part 71 instructs the rotation drive 63 of the optical axis changing assembly 12 to change the state of the optical axis in accordance with, for example, the timing of receiving the speed detection of the vehicle 3 using the speed detector 3a or the timing of capturing an image suing the imaging device 11 at a constant frame rate.

The controller 15 transmits an exposure control signal to the camera controller 27. The exposure control signal includes two types of signals, an Hi signal as an ON signal for instructing exposure and a Low signal as an OFF signal for not instructing exposure. In a case where imaging is performed at a constant frame rate, the camera controller 27 may control exposure instead of the controller 15.

The storage 17 is a storage medium that stores programs and data necessary for implementing the functions of the controller 15. The storage 17 can be implemented by, for example, a hard disk (HDD), a solid-state disk (SSD), a random access memory (RAM), a dynamic random access memory (DRAM), a ferroelectric memory, a flash memory, a magnetic disk, or a combination thereof.

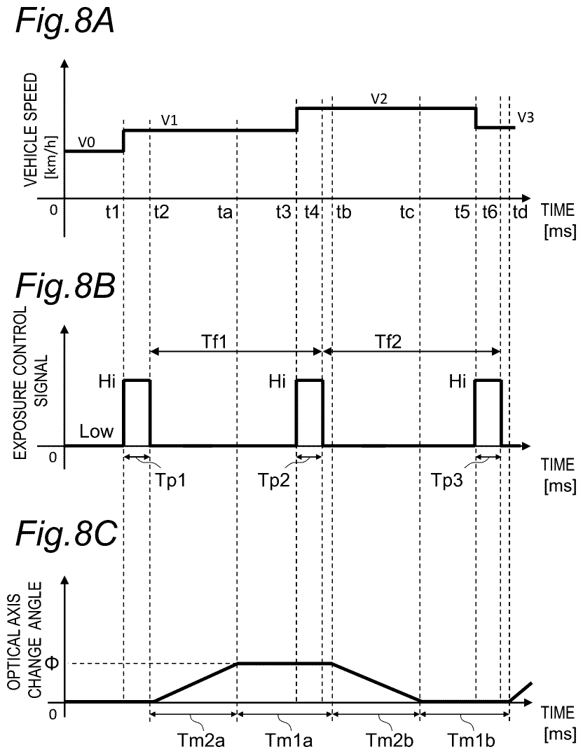

The operation unit 19 is an input device for the user to instruct the controller 15. The operation unit 19 may be an input device such as a keypad or touch panel dedicated to the imaging system 1 or a mobile terminal such as a smartphone. In a case where a mobile terminal is used as the operation unit 19, the operation unit 19 and the controller 15 transmit and receive data via wireless communication. The user may use the operation unit 19 to instruct the controller 15 to determine that the imaging target region is an indoor dark region, such as a tunnel, or an outdoor bright region, such as a slope of a mountain or a road, or to determine a capturing interval Tf. The capturing interval Tf is a time between a timing at which capturing of a current image is completed and a timing at which capturing of a next image is completed. In a case of capturing a moving image, the capturing interval Tf is one frame time, and in a case of capturing a still image, it is a time interval of image capturing times. FIG. 8A-8C illustrate capturing intervals Tf1 and Tf2 for each image as the capturing interval Tf, and exposure times Tp1, Tp2, and Tp3 for each image as the exposure time Tp. The exposure times Tp1, Tp2, and Tp3 are times from imaging start times t1, t3, and t5 to imaging end times t2, t4, and t6, respectively. In the case of capturing a moving image, a frame rate (the number of images to be captured per second) may be designated. Further, the user may use the operation unit 19 to instruct the controller 15 to switch between the first imaging mode for operating the optical axis changing assembly 12 and the second imaging mode for not operating the optical axis changing assembly 12.

### [1-2. Operation of Imaging System]

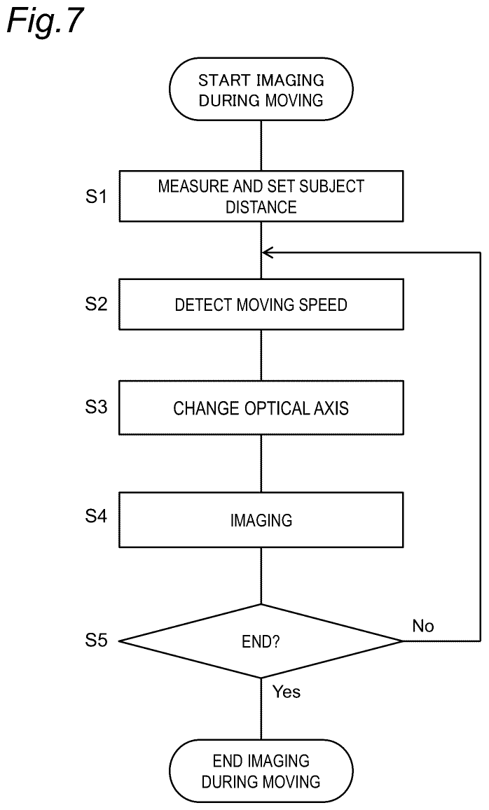

The operation of the imaging system 1 will be described below with reference to FIGS. 7 and 8A-8C. FIG. 7 is a flowchart illustrating imaging processing performed by the imaging system 1. FIG. 8A-8C are graphs illustrating a relationship between the exposure time and the optical axis change timing. FIG. 8A is the graph illustrating a temporal change of a vehicle speed. FIG. 8B is the graph illustrating an output timing of the exposure control signal. FIG. 8C is the graph illustrating a temporal change of the optical axis change angle Φ. The imaging processing illustrated in FIG. 7 is started, for example, when an instruction to start imaging is issued from the operation unit 19 while the vehicle 3 is moving.

In step S1, the user measures in advance a subject distance from the imaging element 25 of the camera body 21 to the road surface of the road 4 as the imaging target, and sets the measured subject distance for the controller 15 using the operation unit 19. Further, by setting the section of the road to be imaged, for example, the controller 15 can determine whether the vehicle has traveled on the road in the set section, based on global positioning system (GPS) information and a traveling distance.

In step S2, the vehicle 3 starts traveling, and the speed detector 3a detects the moving speed of the vehicle 3. The detected moving speed is sent to the controller 15. In the first embodiment, the imaging is performed in synchronization with the detection of the speed using the speed detector 3a, but the imaging may be performed at a predetermined cycle, or the user may set the imaging cycle with the operation unit 19. A case where the exposure is synchronized with a vehicle speed pulse is described. For example, in a case where the speed is detected at intervals of 40 cm of the moving distance of the vehicle 3, and the traveling speed is 60 km/h, the frame rate becomes about 40 fps. Further, the speed detector 3a does not have to detect an accurate moving speed, and may detect that the vehicle is moving. The detected moving state is sent to the controller 15. In addition to the instruction to start the imaging from the user using the operation unit 19, the controller 15 may perform the imaging after detecting that the vehicle 3 is in the moving state. The distance interval of the speed detection may be changed according to the specification of the speed detector 3a.

In step S3, when the number of images to be captured next is two or more, the optical axis change instruction part 71 of the controller 15 instructs the rotation drive 63 of the optical axis changing assembly 12 to rotate. As a result, the imaging direction of the imaging device 11 is changed. In the case of capturing the first image, the optical axis change instruction part 71 may not instruct the rotation drive 63 to rotate. In this case, the optical axis of the imaging device 11 is located at the initial position (optical axis change angle Φ=0). In the first embodiment, after the first image Im1 is captured, the optical axis of the imaging device 11 is fixed during a first time Tm1, and the optical axis of the imaging device 11 is rotated during a second time Tm2. In FIG. 8A-8C, Tm1a and Tm1b are indicated as the first time Tm1, and Tm2a and Tm2b are indicated as the second time Tm2. The change of the optical axis of the imaging device 11 starts at the time t2 at which the capturing of the first image Im1 ends, and the change of the optical axis of the imaging device 11 ends at the time ta. A period from the time t2 to the time ta is the second time Tm2a.

After the optical axis changing operation of the rotation drive 63 ends, the optical axis of the imaging device 11 is fixed during the first time Tm1a from the time ta to a time tb. The time tb is later than the time t4 at which the capturing of the second image Im2 ends. The optical axis change instruction part 71 controls the optical axis changing assembly 12 so that the exposure time Tp≤the first time Tm 1<the capturing interval Tf and the exposure time Tp is included in the period of the first time Tm1. According to this control, while the rotation drive 63 is changing the optical axis of the imaging device 11, the exposure instruction is not issued from the controller 15 to the camera controller 27. Therefore, the influence of the optical axis change on an image blur can be avoided with high accuracy. On the other hand, the possible value range of the second time Tm2 is Tm2=Tf−Tm1 and Tm2>0. When the exposure time Tp is used, the possible value range of the second time Tm2 is 0<Tm2≤Tf−Tp. Therefore, in consideration of the responsiveness of the optical axis changing assembly 12, in a case where the second time Tm2 has to be secured as long as possible, the first time Tm1 may be shortened. In this case, the first time Tm1 may not satisfy the condition that the exposure time Tp≤the first time Tm1. For example, the first time Tm1 may satisfy a condition that Tp/2≤Tm1<Tf. Under this condition, the stop period of the optical axis changing assembly 12 during exposure is longer than or equal to the period of changing the optical axis by the optical axis changing assembly 12, and the stop period of the optical axis changing assembly 12 is dominant in imaging during exposure. In this manner, the first time Tm1 is determined based on the capturing interval Tf and the exposure time Tp, and the second time Tm2 is determined based on the capturing interval Tf and the first time Tm1.

During the first time Tm1a, in step S4, the controller 15 continues to send a Hi signal to the camera controller 27 of the imaging device 11 during the exposure time Tp2, for example. As a result, the imaging element 25 images the imaging target during the exposure time Tp2. The image captured by the imaging element 25 is recorded from the camera controller 27 to the storage 17 to acquire the captured image.

In step S5, the controller 15 determines whether the vehicle 3 has traveled in a predetermined section. When the controller 15 determines that the vehicle 3 has finished traveling in the predetermined section, the image acquisition of the road in this section ends. The controller 15 then ends the imaging during moving. Alternatively, when the user operates the operation unit 19, the controller 15 may end the imaging during moving according to the instruction from the operation unit 19. When determining that the vehicle 3 has not finished traveling in the predetermined section, the controller 15 returns to step S2 to perform the imaging during moving again. In step S3, after the first time Tm1a has elapsed, the optical axis change instruction part 71 instructs the rotation drive 63 of the optical axis changing assembly 12 to rotate so as to return the optical axis of the imaging device 11 to the initial position (optical axis change angle Φ=0) during the second time Tm2b from the time tb to a time tc. After the optical axis changing operation of the rotation drive 63 ends, the optical axis of the imaging device 11 is fixed during the first time Tm1b from the time tc to a time td. The time td is later than the time t6 at which the capturing of the third image Im3 ends. During the first time Tm1b, in step S4, the controller 15 continues to send, for example, a Hi signal to the camera controller 27 of the imaging device 11 during the exposure time Tp3. As a result, the imaging element 25 images the imaging target during the exposure time Tp3.

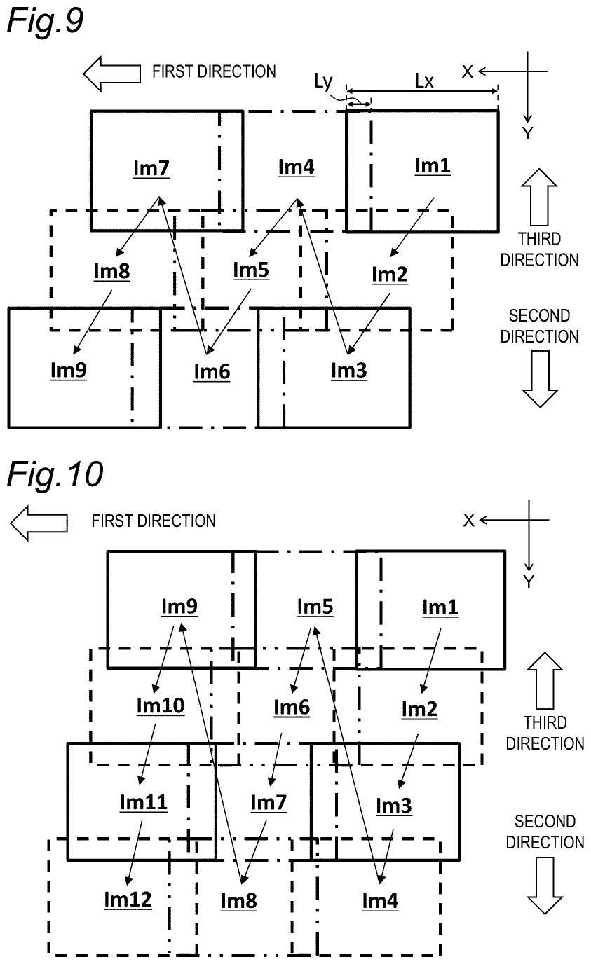

A modification of the first embodiment will be described with reference to FIGS. 9 and 10. In the first embodiment, the optical axis of the imaging device 11 has the states of two optical axes, the first optical axis 23ab and the second optical axis 23ac, but the present disclosure is not limited thereto. The optical axis changing assembly 12 may change the optical axis of the imaging device 11 to states of k optical axes to sequentially change the optical axis of the imaging device 11 in the second direction. Here, k is a number of two or more. The imaging device has three or more optical axis states. The optical axis changing assembly 12 may displace the imaging device 11 to the respective optical axis states. The imaging device 11 then may image the imaging target in the respective optical axis states. This makes it possible to expand the imaging range.

FIG. 9 illustrates a relationship between the imaging order and the captured images in a case where the imaging device 11 has three optical axis states. The optical axis changing assembly 12 makes a change to the states of three (k=3) optical axes to sequentially change the optical axis of the imaging device 11 in the second direction. The imaging device 11 captures the rth image that satisfies the condition that 2≤r≤n in the total number n of images to be captured. In a case where r is not a multiple of k, that is, r is not a multiple of 3 (r/3 is not an integer), for example, r=5, the optical axis of the imaging device is changed in the second direction for capturing of the sixth image with respect to the time of capturing the fifth image. In a case where r is the multiple of k, that is, r is the multiple of 3 (r/3 is an integer), for example, r=6, the optical axis of the imaging device 11 is changed in a third direction opposite to the second direction for the capturing of a seventh image with respect to the time of capturing the sixth image. The controller 15 operates the optical axis changing assembly 12 between the timing of capturing the first image and the timing of capturing the second image and between the timing of capturing the rth image and the timing of capturing the (r+1)th image. The captured (r+1)th image is an image in the first direction at the time of capturing the rth image. This makes it possible to expand the imaging range to be wider than the case where two images are captured in the second direction. Further, the controller 15 calculates a capturing interval Tfk between the capturing of the rth image and capturing of an (r+k)th image based on the moving speed of the vehicle 3. It is assumed that the imaging range of one image in the traveling direction is Lx [m], the overlapping range of the images in the traveling direction is Ly [m], and the moving speed is V [km/h]. A time interval Tx [sec] between the capturing of the rth image and the capturing of the (r+k)th image satisfies the following Equation. Here, a coefficient c is a coefficient for converting the units of distance [m] and [km] and the units of time [hour] and [sec], and is 3.6.

$$Tx \leq c \times ( L x - Ly ) / V$$

Assuming that the minimum necessary overlapping range of the images in the traveling direction is Lymin [m], a maximum value Txmax of the time interval Tx is calculated according to c×(Lx−Lymin)/V, and the time interval Tx may be set to Txmax or less. The minimum necessary overlapping range Lymin of the images in the traveling direction is a range for joining continuous images to one image by image recognition. For example, Lymin may be 20% or more of the imaging range Lx. The number k of changeable optical axis states can be calculated based on the set time interval Tx and capturing interval Tf. The number k is calculated as an integer satisfying the following Equation.

$$k \leq Tx / Tf$$

Since the movement amount of the optical axis from the (r+k−1)th image to the (r+k)th image is great, k cannot be the maximum integer satisfying the above Equation. In this case, k is set to the maximum integer −1.

The controller 15 may calculate the capturing interval Tf between the capturing of the rth image and the capturing of the (r+1)th image based on the moving speed and the number k of changeable optical axes. As described above, in a certain case, the capturing interval Tf is calculated based on the time interval Tx set based on the moving speed V and the number k of the optical axis states to be changed. The capturing interval Tf is set to a value satisfying the following Equation.

$$T f \leq Tx / k$$

In order to suppress an increase in the storage capacity of image data due to an increase in the number of acquired images, the capturing interval Tf may be such that

$$T f = Tx / k .$$

In the case where r/k is not an integer, the optical axis change angle Φ through which the optical axis of the imaging device 11 is changed at the time of capturing between the capturing the (r+1)th image with respect to the time of capturing the rth image is equal to or smaller than the angle of view a of the imaging device 11. Since the captured rth image and the captured (r+k)th image have a common imaging region, the captured rth image, the captured (r+1)th image, and the captured (r+k)th image have the common imaging region. For example, in the case of r=4, r/k is not an integer. Therefore, since the fourth image Im4 and the seventh image Im7 have a common imaging region, the fourth image Im4 and the fifth image Im5 have a common imaging region, and the fifth image Im5 and the seventh image Im7 have a common imaging region.

FIG. 10 illustrates a relationship between the imaging order and the captured images in a case where the imaging device 11 has four optical axis states. The optical axis changing assembly 12 makes a change to the states of four (k=4) optical axes to sequentially change the optical axes of the imaging device 11 in the second direction. The controller 15 calculates the capturing interval Tf between the capturing of the rth image and the capturing of the (r+1)th image based on the moving speed and the number k of the optical axes (k=4). The imaging device 11 captures the rth image satisfying the condition that 2≤r≤n where n represents the total number of images to be captured. In a case where r is not a multiple of 4 (r/4 is not an integer), for example, r=5, the optical axis of the imaging device is changed in the second direction for the capturing of the sixth image with respect to the time of capturing the fifth image. In a case where r is a multiple of 4 (r/4 is an integer), for example, r=8, the optical axis of the imaging device 11 is changed in the third direction opposite to the second direction for capturing of a ninth image with respect to the time of capturing an eighth image. This makes it possible to expand the imaging range to be wider than the cases where two and three images are captured in the second direction. For example, in the case where r/k is not an integer, for example, r=5, the fifth image Im5 and the ninth image Im9 have a common imaging region. As a result, the fifth image Im5 and the sixth image Im6 have a common imaging region, and the sixth image Im6 and the ninth image Im9 have a common imaging region.

### 3. Effects, Etc.

As described above, the imaging system 1 includes the imaging device 11 disposed in the vehicle 3, the optical axis changing assembly 12, and the controller 15. The optical axis changing assembly 12 changes, when the imaging device 11 performs imaging while the vehicle 3 is moving in the first direction as the +X-axis direction, the optical axis of the imaging device 11 to the states of k optical axes, k being an integer of two or more. At this time, the optical axis 23a of the imaging device 11 changes from the state of the first optical axis 23ab of the imaging device 11 at the time of capturing the first image to the state of the second optical axis 23ac displaced in the Y-axis direction intersecting the +X-axis direction at the time of capturing the second image. In such a way, the optical axis changing assembly 12 sequentially changes the optical axis of the imaging device 11 in the second direction. The controller 15 operates the optical axis changing assembly 12. The controller 15 operates the optical axis changing assembly between the timing of capturing the first image and the timing of capturing the second image and between the timing of capturing the rth image and the timing of capturing the (r+1)th image after the imaging device 11 captures the rth image satisfying the condition that 2≤r≤n (n is an integer of two or more) in the total number n of captured images.

In the vehicle 3 that is moving, the range of an image to be captured can be expanded by changing the optical axis of the imaging device 11 to the states of two or more optical axes. Since an image is not captured while the optical axis is being changed, the captured image can be prevented from having a blur.

In the capturing of the rth image and the (r+1)th image, the controller 15 operates the optical axis changing assembly 12 so that the optical axis of the imaging device 11 is fixed during the first time Tm1 based on the capturing interval Tf between the rth image and the (r+1)th image and the exposure time Tp of the imaging device 11, and the optical axis of the imaging device 11 is changed at the second time Tm2 based on the capturing interval Tf between the timing of capturing the rth image and the timing of capturing the (r+1)th image and the first time Tm1. As a result, since the optical axis of the imaging device 11 is fixed during capturing of an image, an imaging blur due to rotation of the optical axis can be prevented.

In the case where r/k is not an integer, the optical axis change angle Φ through which the optical axis of the imaging device 11 is changed at the time of capturing the (r+1)th image from the state capturing the rth image is equal to or smaller than the angle of view a of the imaging device 11. As a result, in the second direction, the rth image and the (r+1)th image can be continuous without a gap or have an overlapping region.

In a case where r is not divisible by k (r/k is not an integer), the optical axis changing assembly 12 changes the optical axis of the imaging device 11 in the second direction for the capturing of the (r+1)th image with respect to the time of capturing the rth image. In the case where r/k is an integer, the optical axis changing assembly 12 changes the optical axis of the imaging device in the third direction opposite to the second direction for the capturing of the (r+1)th image with respect to the time of capturing the rth image.

In the case where r/k is an integer, the optical axis changing assembly 12 changes the optical axis of the imaging device 11 to the state of the first optical axis displaced in the third direction at the time of capturing the (r+1)th image with respect to the time of capturing the rth image.

The captured (r+k)th image is an image acquired by imaging the imaging target region 9 located in the first direction with respect to the imaging target region 9 imaged to obtain the captured rth image. The end region on the side opposite to the first direction in the captured (r+k)th image overlaps with the end region in the first direction in the captured rth image. This makes it possible to prevent imaging omission between images in the first direction.

The controller 15 has a first imaging mode and a second imaging mode. In the first imaging mode, the imaging device 11 performs imaging while the optical axis changing assembly 12 is being operated between the timing of capturing the first image and the timing of capturing the second image and between the timing of capturing the rth image and the timing of capturing the (r+1)th image. In the second imaging mode, the imaging device 11 continuously performs imaging without operating the optical axis changing assembly 12. This makes it possible to select the imaging mode in accordance with the imaging range.

### Second Embodiment

An imaging system 1A according to a second embodiment images an imaging target while changing states of two optical axes, but in the first state C1 and the second state C2, respective optical axes are inclined with respect to the imaging target. The points of the configuration other than the above-described point and points described below are common between the imaging system 1A according to the second embodiment and the imaging system 1 according to the first embodiment.

In the imaging system 1 according to the first embodiment, the lens 23 is placed at a position facing the imaging target, that is, an axis perpendicular to the imaging target surface and the optical axis are parallel to each other. As a result, the subject distance in an imaging plane in the first state C1 becomes uniform, and thus a focused image can be captured. The imaging device 11 is displaced to the second state C2 in order to capture an image while the imaging direction of the camera is being changed for enabling imaging a wide range by one imaging while traveling. This results in a deviation of the position of the lens 23 from the facing position, and thus variation in the subject distance in the imaging plane occurs. As a result, a slightly blurred image may be captured.

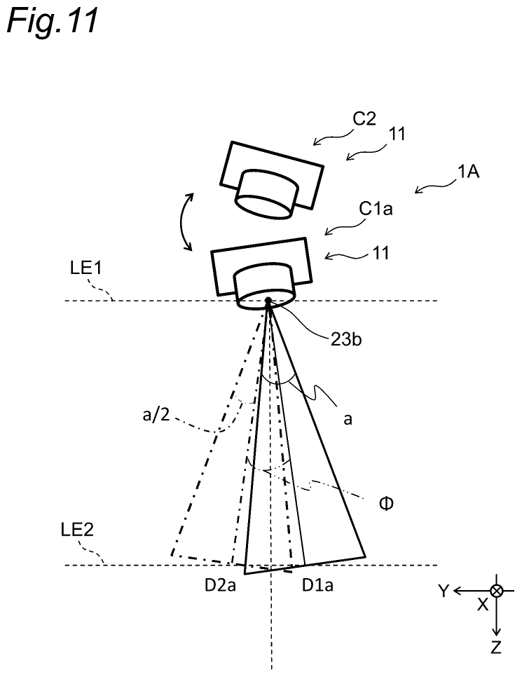

Therefore, in the imaging system 1 of the second embodiment, the installation position of the imaging device 11 is inclined in consideration of the optical axis change. As illustrated in FIG. 11, the imaging device 11 is installed with an installation inclination. At this time, that the imaging direction is inclined about an axis parallel to the moving direction in a plane intersecting the moving direction of the vehicle 3 by a predetermined angle smaller than the optical axis change angle Φ of the optical axis changing assembly 12, with respect to the imaging target region of the imaging device 11. For example, in FIG. 11, the moving direction of the vehicle 3 is the X-axis direction orthogonal to the paper surface. Further, a position where the imaging direction is inclined by a half/2 of the optical axis change angle to be set so that the imaging direction is inclined around the X axis parallel to the moving direction in a YZ plane intersecting the moving direction of the vehicle 3 is the position of the first state C1a.

Such a configuration makes it possible to make a subject distance D1a in the first state C1a equal to a subject distance D2a in the second state C2. It is possible to reduce a change in the subject distance of the images captured in the first state C1 and the second state C2 at the two positions. For this reason, the imaging target can be imaged symmetrically at the initial position (first state C1a) and the optical axis change position (second state C2). Therefore, both equalization of imaging accuracy and increase in the angle of view at both positions can be achieved.

### Third Embodiment

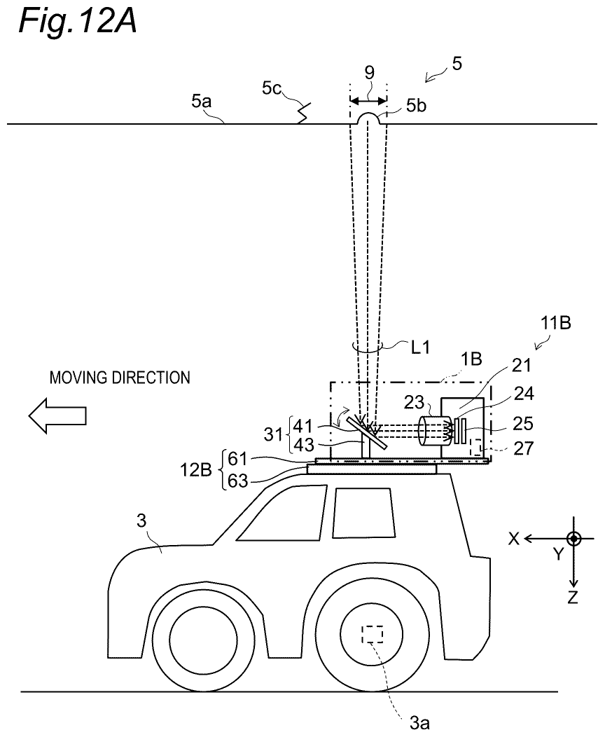

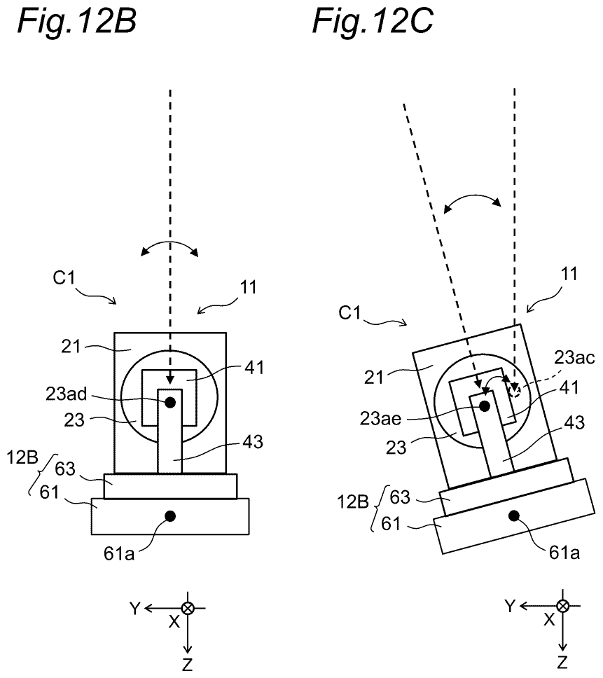

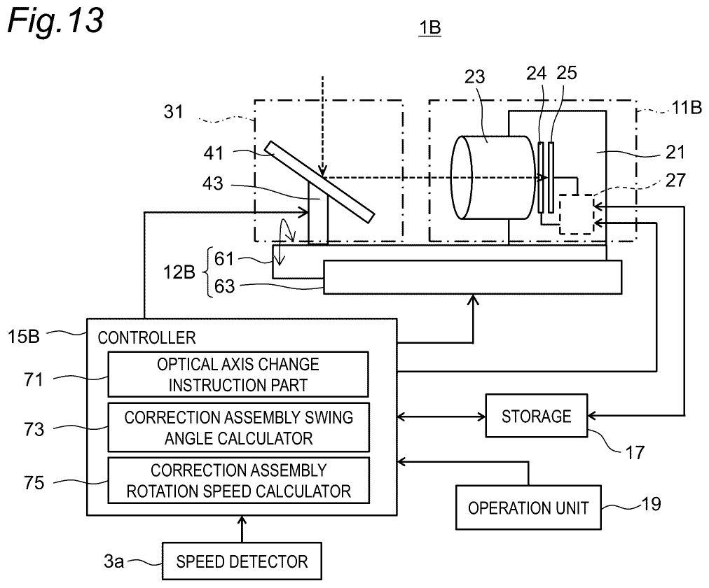

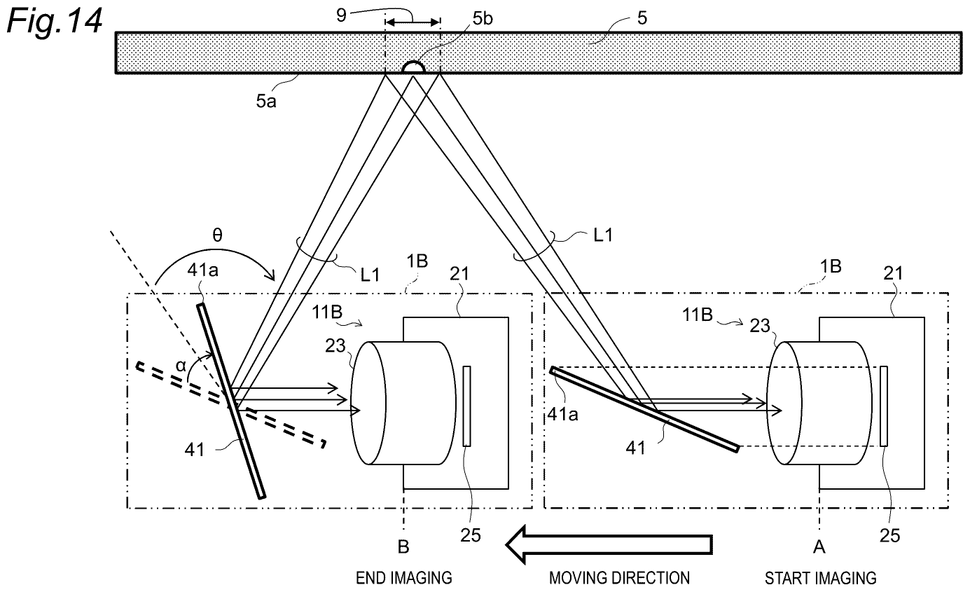

An imaging system 1B according to a third embodiment will be described with reference to FIGS. 12A to 15. FIG. 12A is an explanatory diagram for explaining the vehicle 3 including an imaging system 1B according to the third embodiment. FIGS. 12B and 12C are explanatory diagrams for explaining states of the imaging device in respective states of two optical axes in the third embodiment. FIG. 13 is a block diagram illustrating an internal configuration of the imaging system 1B according to the third embodiment. FIG. 14 is an explanatory diagram for explaining blur correction of the imaging system 1B.

The imaging system 1B in the third embodiment has a configuration where the imaging system 1 of the first embodiment includes a blur correction assembly 31. The points of the configuration other than the above-described point and points described below are common between the imaging system 1B according to the third embodiment and the imaging system 1 according to the first embodiment.

As illustrated in FIG. 12A, the vehicle 3 is traveling in a tunnel 5, for example. For example, a hole 5b or a crack 5c occurs on a wall surface 5a in the tunnel 5. As described above, in the case of imaging in dark ambient light, such as in the tunnel 5, extending the exposure time causes a movement blur in the captured image. Further, in a case where the image of a subject is captured while the vehicle 3 is traveling at a high speed, a movement blur occurs in the captured image. The blur correction assembly 31 corrects the optical path of light injected to the imaging system 1 so as to reduce the movement blur in the image of the imaging target region 9 even if an imaging device 11B performs imaging while the vehicle 3 is moving.

The camera body 21 is disposed in the vehicle 3 so that the direction of the lens 23 is parallel to the moving direction of the vehicle 3. For example, the camera body 21 is disposed so that the lens 23 faces forward or backward of the vehicle 3.

The blur correction assembly 31 corrects the optical path of light L1, which is the ambient light reflected by the imaging target region 9, in accordance with the movement of the vehicle 3. The blur correction assembly 31 matches the direction of the light L1, which is the ambient light reflected by the imaging target region 9, with the imaging direction of the imaging element 25. The blur correction assembly 31 includes, for example, a mirror 41 and a mirror drive 43. The mirror 41 totally reflects the light, which is the ambient light reflected by the imaging subject, toward imaging device 11.

As illustrated in FIGS. 12B and 12C, when the imaging device 11 performs imaging while the vehicle 3 is moving in the first direction that is the +X-axis direction, the optical axis changing assembly 12B changes the optical axis 23a of the lens 23, from the first optical axis 23ad to the second optical axis 23ae, in the lens 23 of the imaging device 11 at the time of capturing the first image. The first optical axis 23ad directs perpendicularly toward the ceiling of the tunnel 5 at the time of capturing the first image. The second optical axis 23ae is inclined and displaced in the second direction that is the +Y-axis direction intersecting the first direction at the time of capturing the second image. The optical axis changing assembly 12B rotates both the blur correction assembly 31 supported by the base 61 around a rotation shaft 61a and the imaging device 11B. Therefore, by driving the optical axis changing assembly 12B, the optical axis of the blur correction assembly 31 is changed accordingly together with the optical axis of the imaging device 11.

Note that the blur correction assembly 31 and the optical axis changing assembly 12B are not limited to this configuration. In a case where the imaging device 11B has a configuration where the camera body 21 and the lens 23 are integrated, a pan tilt rotation assembly for rotating the camera body 21 and the lens 23 about the rotation axis may be used. In this case, the blur correction assembly 31 corresponds to a assembly that rotationally drives the camera body 21 and the lens 23 in the tilt direction, and the optical axis changing assembly 12B corresponds to a assembly that rotationally drives them in the pan direction. In a case where the lens 23 is rotated by 90 degrees and installed vertically, the blur correction assembly 31 is a assembly that rotates the lens in the pan direction, and the optical axis changing assembly 12B is a assembly that rotationally drives the lens in the tilt direction. In this manner, when the lens 23 is caused to directly face the subject, the assembly can rotate in the pan direction in accordance with the traveling direction. As a result, the traveling direction can be a long side direction of the imaging element 25, and the overlapping of the captured images in the moving direction is easily secured even if the speed of the vehicle 3 becomes high.

In a case where a assembly that rotates the camera body 21 and the lens 23 in one axis direction is provided, the assembly that rotates in one axis direction may be used as the optical axis changing assembly 12B. In this case, the blur correction assembly 31 includes, for example, a mirror 41 and a mirror drive 43. The blur correction assembly 31 and the optical axis changing assembly 12B may be configured by two mirrors and a motors. Their rotation axes are orthogonal to each other. The imaging device 11B may be entirely rotated in two orthogonal directions. Further, a assembly that rotationally drives the camera body 21 and the lens 23 in the pan direction may be used as the optical axis changing assembly 12B, and a assembly that entirely rotates the imaging device 11B in the tilt direction may be used as the blur correction assembly 31.

The mirror 41 is rotatably disposed to face the lens 23. For example, the mirror 41 is rotatable in both a clockwise, i.e. normal direction and a reverse direction, and the rotatable angular range may be less than 360 degrees or 360 degrees or more. The mirror 41 totally reflects the light, which is the ambient light reflected by the imaging subject, toward imaging device 11. The mirror drive 43 rotationally drives the mirror 41 from the initial angle to an instructed angle, and returns the mirror 41 to the initial angle again after rotating the mirror to the instructed angle. The mirror drive 43 is, for example, a motor.

The rotation angle of the mirror 41 is limited by the mechanical restriction of the mirror drive 43. The mirror 41 can be rotated to a maximum swing angle of the mirror 41 determined by this restriction. A movement blur correction angle θ at which a movement blur correction can be made is equal to or smaller than the maximum swing angle of the mirror 41.

With reference to FIG. 14, the blur correction made by the blur correction assembly 31 will be described. For example, it is assumed that the imaging system 1 located at a position A moves to a position B during the exposure time together with the vehicle 3. It is assumed that imaging is started at the position A and an image is acquired at this timing. In the image acquired at the position A, for example, the hole 5b of the imaging target region 9 is imaged, but due to insufficient exposure time, the image is dark and unclear.

Therefore, the exposure is continued until the vehicle 3 moves to the position B. In this case, if no blur correction is made, the imaging target region 9 relatively moves in the direction opposite to the moving direction of the vehicle 3, thereby obtaining the image in which the hole 5b is relatively moved. In the image in which the exposure is continued, the movement amount of pixels is detected as the blur amount. As described above, the image captured by the imaging device 11 while the vehicle 3 is moving becomes a blurred image.

Therefore, according to the moving speed of the imaging system 1B and the vehicle 3, the mirror 41 is rotated in the direction where an end 41a of the mirror 41 on the moving direction side offsets the relative movement of the imaging target during the exposure time. This enables the imaging system 1 to image the same imaging target region 9 in the captured image during the exposure time, and to acquire an image in which the movement blur is greatly reduced. In FIG. 14, the mirror 41 is rotated clockwise so that the end 41a of the mirror 41 on the moving direction side turns toward the imaging target side during the exposure time. By rotating the mirror 41, the movement amount of the pixels in the captured image is corrected to 0.

FIG. 13 is referred to. A controller 15B includes the optical axis change instruction part 71, a correction assembly swing angle calculator 73, and a correction assembly rotation speed calculator 75.

The correction assembly swing angle calculator 73 calculates a mirror swing angle α of the mirror 41 during imaging in the following flow based on the moving speed V of the vehicle 3, the set exposure time Tp, a subject magnification M, and the focal length F of the lens 23. The mirror swing angle α corresponds to the correction assembly swing angle.

The focal length F is a value determined by the lens 23. The subject magnification M is a value determined by the focal length F and the subject distance D. The subject distance D is a distance from the principal point 23b of the lens 23 disposed between an imaging target, which is a subject, and the imaging element 25 to imaging target region 9. As the subject distance D, a known value measured in advance may be used, or a value measured by a distance meter during imaging may be used.

A movement amount L of the vehicle 3 that has moved during the exposure time Tp from the imaging start time to the imaging end time is calculated based on the moving speed V and the exposure time Tp according to the following Equation (3).

$$L [ mm ] = V [ km / h ] \times 1 {0}^{6} \times Tp [ ms ] / ( {60}^{2} \times 1 {0}^{3} ) \qquad Equation ( 3 )$$

A movement amount P of the pixel on the imaging element 25 from the imaging start time to the imaging end time is calculated based on the movement amount L of the vehicle 3 and the subject magnification M according to the following Equation (4).

$$P [ mm ] = L [ mm ] \times M \qquad Equation ( 4 )$$

Since the movement amount P of the pixel causes a movement blur, the optical path of the light projected to the lens 23 is changed by the movement blur correction angle θ in accordance with the movement amount P of the pixel so that the movement blur does not occur. The movement blur correction angle θ is calculated based on the movement amount P of the pixel and the focal length F according to the following Equation (5).

$$θ [ deg ] = arctan ( P / F ) \qquad Equation ( 5 )$$

As described above, the subject magnification M is calculated based on the focal length F [mm] and the subject distance D [m] according to the following Equation (6).

$$M = F / ( D \times 1 {0}^{3} ) \qquad Equation ( 6 )$$

According to Equations (3), (4), (5), and (6),

$$θ = arctan ( V \times 1 {0}^{6} \times Tp / ( {60}^{2} \times 1 {0}^{3} ) / ( D \times 1 {0}^{3} ) ) = arctan ( V \times Tp / ( D \times 6 {0}^{2} ) ) \qquad Equation ( 7 )$$

In such a manner, the movement blur correction angle θ is calculated based on the moving speed V, the exposure time Tp, and the subject distance D.

Since the mirror swing angle α necessary for a movement blur correction during exposure is half the movement blur correction angle θ, the mirror swing angle α is calculated according to the following Equation (8).

$$α = θ / q \qquad Equation ( 8 )$$

Here, in a case of a configuration in which light from the imaging target travels through the mirror 41, the lens 23, and the imaging element 25 in this order as in the embodiment of FIG. 13, the coefficient q is 2. Further, in the case of the configuration including the pan-tilt assembly and the entire camera drive, the coefficient q is 1.

In this manner, the correction assembly swing angle calculator 73 calculates the mirror swing angle α of the mirror 41.

The correction assembly rotation speed calculator 75 calculates a rotation speed Vm of the mirror 41 during the exposure period according to the following equation based on the mirror swing angle α and the exposure time Tp.

$$Vm = α / Tp \qquad Equation ( 9 )$$

In this manner, the rotation speed Vm in accordance with each moving speed V of the vehicle 3 can be calculated. Therefore, by rotating the mirror 41 in the direction opposite to the moving direction at the rotation speed Vm after the start of imaging, the imaging device 11B can receive light from the same imaging target region 9 during the exposure time, and can suppress the occurrence of a movement blur in the captured image.

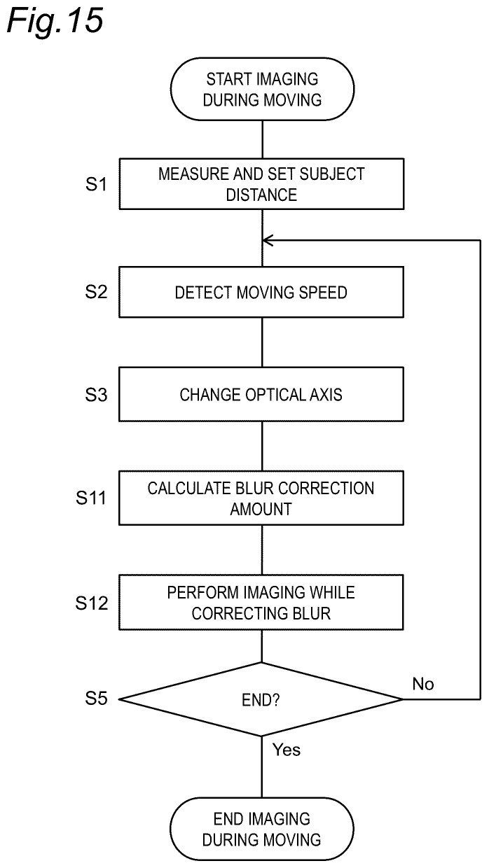

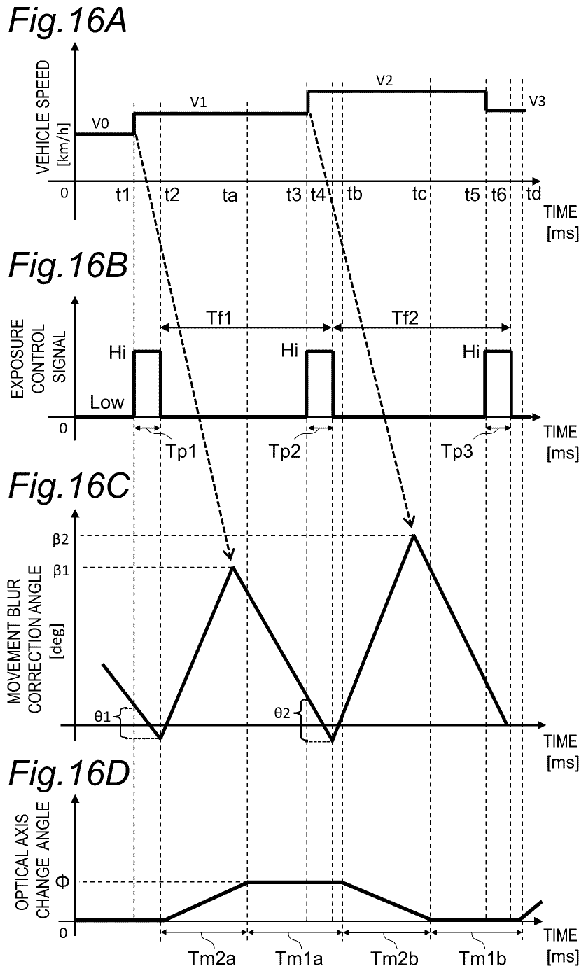

The operation of the imaging system 1B will be described below with reference to FIGS. 15 and 16A-16D. FIG. 15 is a flowchart illustrating imaging processing performed by the imaging system 1B. FIG. 16A-16D are graphs illustrating a relationship between the exposure time, the movement blur correction angle, and the optical axis change angle.

Steps S1 to S3 are similar to the operation of the imaging system 1 in the first embodiment, and thus description thereof is omitted. In step S11, the correction assembly swing angle calculator 73 calculates the mirror swing angle α as the blur correction amount. The correction assembly rotation speed calculator 75 calculates the rotation speed Vm of the mirror 41 based on the mirror swing angle α.

In step S12, the controller 15B causes the mirror drive 43 to rotate the mirror 41 at the calculated rotation speed Vm, and the mirror 41 starts to rotate from a predetermined initial angle that is a rotation start position. As a result, the movement blur correction during imaging by the imaging device 11B is made. At the same time, the controller 15B continues sending a Hi signal instructing exposure to the camera controller 27 for the exposure time Tp.

In the imaging device 11B, the camera controller 27 acquires an image by opening the shutter 24 to perform exposure while receiving the Hi signal (step S12), and stores the acquired image in the storage 17. When the exposure time Tp has elapsed, the controller 15B continues sending, to the camera controller 27, a Low signal as an OFF signal instructing to stop exposure. Note that a Low signal may be used as an ON signal instructing exposure, and a Hi signal may be used as an OFF signal instructing to stop exposure.

While the camera controller 27 is receiving the Low signal, the shutter 24 is closed, and the controller 15B causes the mirror drive 43 to rotate the mirror 41 in the opposite direction to return the mirror 41 to the initial angle. The mirror drive 43 may rotate the mirror 41 in the normal direction to return the mirror 41 to the initial angle. The initial angle varies depending on the moving speed of the vehicle 3.

In a case where images are consecutively captured, the operation of the imaging system 1B after returning to step S1 will be described with reference to FIG. 16A-16D. FIG. 16A-16D are graphs illustrating a relationship between a change in the moving speed, the timing of the exposure time, and the movement blur correction angle. FIG. 16A is a graph illustrating the moving speed of the vehicle 3. The moving speed changes with the lapse of time. FIG. 16B is a graph illustrating the timing of the exposure time at each frame. FIG. 16C is a graph illustrating the movement blur correction angle calculated at each frame. FIG. 16D is a graph illustrating the optical axis change angle.

At a certain time point, an Hi signal indicating an imaging instruction is transmitted, and the first image Im1 is captured. At this time, the speed detector 3a detects the speed of the vehicle 3, and the movement blur correction angle of the next frame is calculated. When the capturing of the first image Im1 ends, the optical axis change instruction part 71 of the controller 15B instructs the optical axis changing assembly 12B to change the optical axis. While the optical axis is being changed, the mirror drive 43 drives the mirror 41 to a rotation start angle β1 in the movement blur correction direction. A broken line extending obliquely from FIG. 16A to FIG. 16C indicates that the movement blur correction amount of the second captured image and the rotation start angle β1 in the correction direction are determined based on a speed V0 at the exposure time of a previous frame. This broken line further indicates that the movement blur correction amount of the third captured image and a rotation start angle β2 in the correction direction are determined based on a speed V1 at the exposure time of the second image. Since FIG. 16C illustrates the blur correction angle which is the optical angle, a mirror mechanical angle in the case of using the mirror 41 is half the rotation start angles β1 and β2 in the correction direction because q=2 in Equation (8) as described above.

The mirror drive 43 starts to rotate the mirror 41 in the direction where the blur is corrected at the rotation speed calculated by the correction assembly rotation speed calculator 75. After the change of the optical axis is completed during the second time Tm2, the controller 15B transmits a Hi signal indicating the imaging instruction to the camera controller 27 during the first time Tm1, during which the optical axis is fixed, and images are captured. As described above, during the imaging, while the blur correction assembly 31 is being driven, the optical axis changing assembly 12B is in an end state of the optical axis changing operation. At this time, the second image is subjected to the blur correction at the movement blur correction angle θ1 in accordance with the speed V0 at the time of capturing the previous image, and the third image is subjected to the blur correction at the movement blur correction angle θ2 in accordance with the speed V1 at the time of capturing the second image. The movement blur correction angle of the fourth image may be calculated in accordance with an average speed of the speed V1 at the time of capturing the second image and the speed V2 at the time of capturing the third image.

As described above, since the angle of view can be expanded while the blur correction is being made in accordance with the moving speed of the vehicle 3, an image of a wide range with high resolution can be acquired.

### Fourth Embodiment

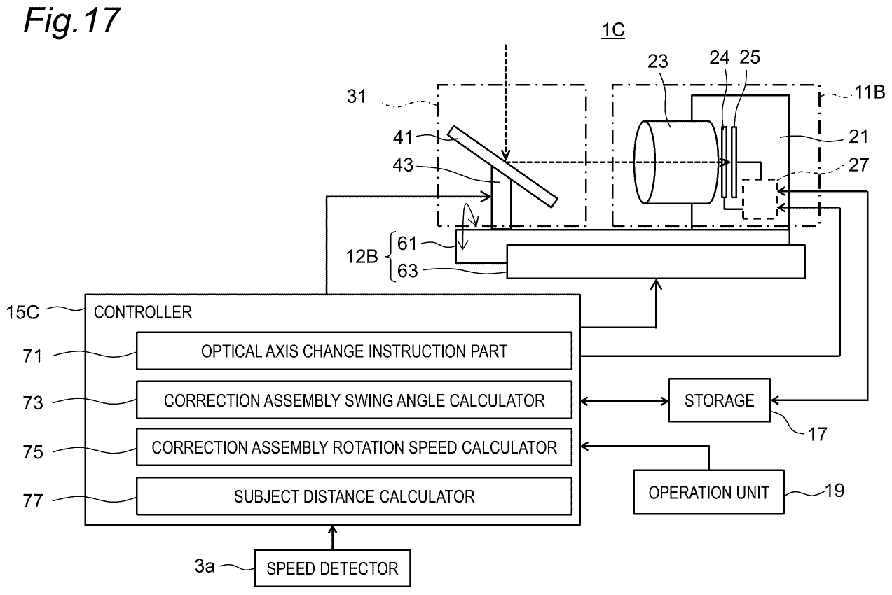

An imaging system 1C according to a fourth embodiment will be described with reference to FIGS. 17, 12B-12C, and 6A-6B. FIG. 17 is a block diagram illustrating an internal configuration of the imaging system 1C according to the fourth embodiment. Note that, in FIGS. 6A and 6B, the imaging target surface has been described as the road surface of the road 4 in the first embodiment, but in the fourth embodiment, the imaging target surface will be described as, for example, a wall surface, particularly a ceiling of the tunnel 5.

The imaging system 1C in the fourth embodiment has a configuration where the controller 15B of the imaging system 1B in the third embodiment includes a subject distance calculator 77. The imaging system 1C in the fourth embodiment calculates the blur correction amount in accordance with the subject distance that varies as the optical axis is displaced. The points of the configuration other than the above-described point and points described below are common between the imaging system 1C according to the fourth embodiment and the imaging system 1B according to the third embodiment.

The subject distance calculator 77 calculates the subject distance on the second optical axis 23ae when the optical axis is displaced from the first optical axis 23ad, which is the initial position, to the second optical axis 23ae. A method for calculating the subject distance on the second optical axis 23ae will be described with reference to FIGS. 12B-12C and 6A-6B. A second subject distance D2 to the imaging target in the state of the second optical axis 23ae and a third subject distance D3 are calculated in the following manner. The second optical axis 23ae is the optical axis of the lens 23 changed through the optical axis change angle Φ from the state of the first optical axis 23ad directing perpendicularly toward the imaging target. The third subject distance D3 is an outer edge of the optical path at the angle of view a on the second optical axis 23ae. The subject distance D3 is a length of a perpendicular line extending down from the end of the optical path at the angle of view a to the imaging surface after the change of the optical axis.

The second subject distance D2 is calculated according to the following Equation (10).

$$D 2 = D 1 / cos ( Φ ) \qquad Equation ( 10 )$$

For example, under the condition of the first embodiment, the second subject distance D2 is 1.706 [m].

The third subject distance D3 is calculated according to the following Equation (11).

$$D 3 = [ D 1 / cos \{ Φ + ( a / 2 ) \} ] \times sin ( 90 - Φ ) \qquad Equation ( 11 )$$

For example, under the condition of the first embodiment, the third subject distance D3 is 1.73 [m].

Using the second subject distance D2 calculated in this manner, the subject magnification M2 on the second optical axis 23ae is calculated. The subject magnification is substituted into Formula (4), thereby calculating the movement amount P2 of the pixel on the second optical axis 23ae. The mirror swing angle α can be calculated according to Equations (5) and (8) using the movement amount P2 of the pixel.

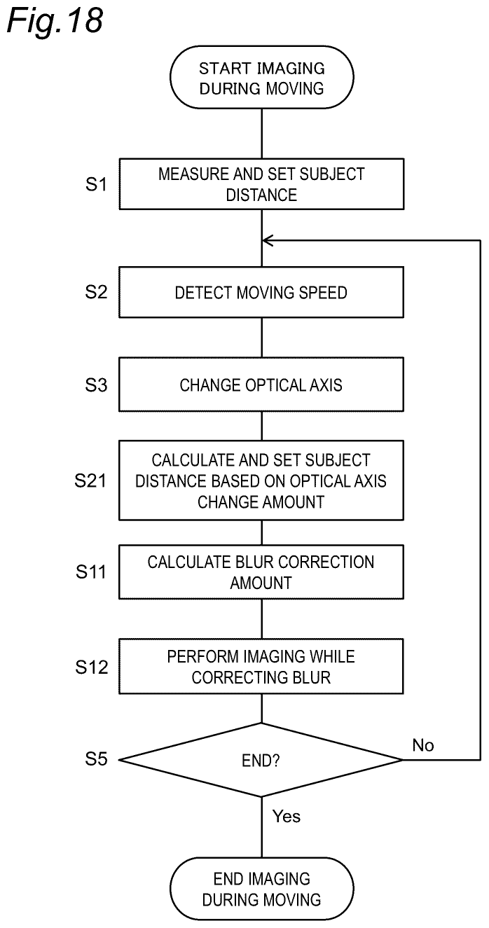

An operation of the imaging system 1C in the fourth embodiment will be described with reference to FIG. 18. FIG. 18 is a flowchart illustrating imaging processing in the fourth embodiment. In the operation of the imaging system 1C in the fourth embodiment, step S21 is added to the operation of the imaging system 1B in the third exemplary embodiment.

Steps S1 to S3, S5, S11, and S12 are similar to the operation of the imaging system 1C in the third embodiment, and thus description thereof is omitted. After the change of the optical axis in step S3, the subject distance calculator 77 calculates the second subject distance D2 based on the optical axis change angle Φ in step S21, and newly sets the calculated second subject distance D2 as the subject distance to the imaging target. As described above, a controller 15C calculates the second subject distance D2 from the imaging device 11B to the imaging target region. The second subject distance D2 changes before and after the change of the optical axis, based on the optical axis change angle Φ changed by the optical axis changing assembly 12B. The controller 15C then sets the mirror swing angle α, which is the blur correction amount for correcting a blur in the first direction, based on the second subject distance D2. As a result, in step S11, the accuracy of the correction assembly swing angle (blur amount) calculated by the correction assembly swing angle calculator 73 can be improved. As a result, more accurate tracking can be achieved, and the blur correction can be made with high accuracy.

### Fifth Embodiment

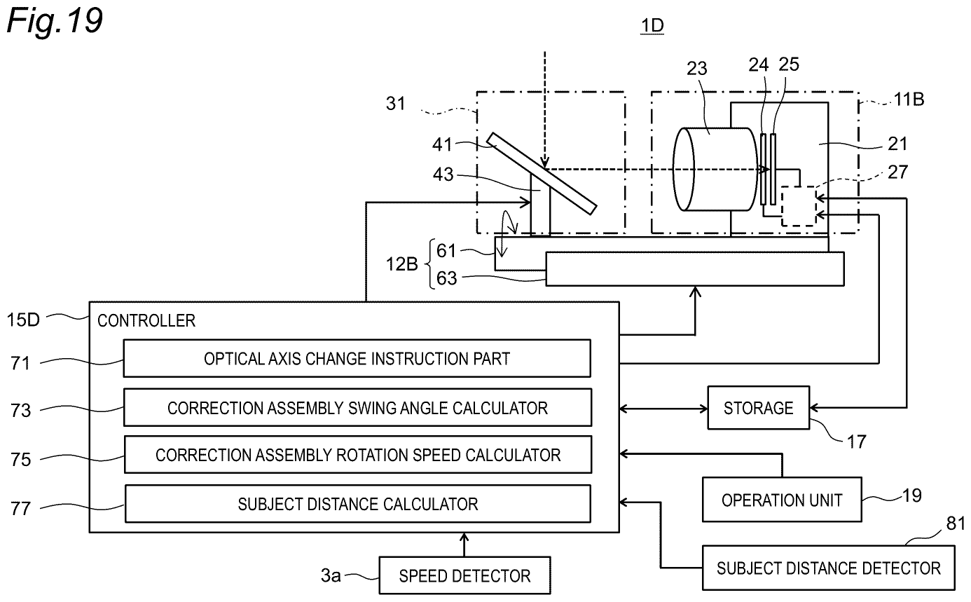

An imaging system 1D according to a fifth embodiment will be described with reference to FIG. 19. FIG. 19 is a block diagram illustrating an internal configuration of the imaging system 1D according to the fifth embodiment.

The imaging system 1D in the fifth embodiment has a configuration where the controller of the imaging system 1C in the fourth embodiment includes a subject distance detector 81. The points of the configuration other than the above-described point and points described below are common between the imaging system 1D according to the fifth embodiment and the imaging system 1C according to the fourth embodiment.

The subject distance detector 81 detects the distance from the principal point of lens 23 to a subject. The subject distance detector 81 is, for example, a laser measuring instrument. Information about the subject distance detected by the subject distance detector 81 is sent to a controller 15D. The correction assembly swing angle calculator 73 of the controller 15D calculates the correction assembly swing angle on the first optical axis 23ad based on the detected first subject distance D1.

By detecting the distance from the principal point of the lens 23 to the subject, the subject distance detector 81 can accurately calculate the blur correction amount even if the distance of the imaging device 11B from the wall surface 5a in the tunnel 5 is changed in accordance with a situation of a site. As a result, the angle of view of the imaging device 11B can be easily adjusted by adjusting the distance of the imaging device 11B with respect to the subject.

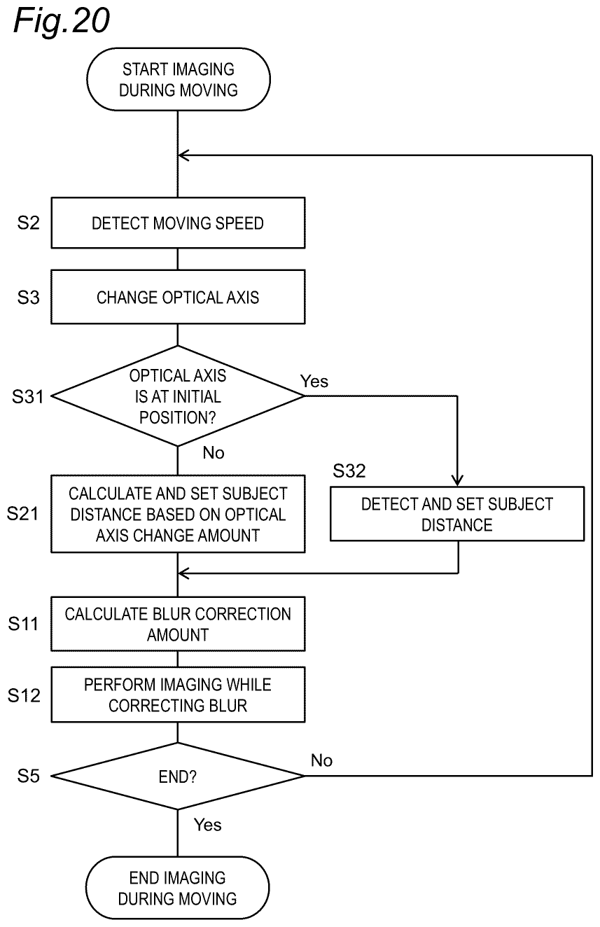

An operation of the imaging system 1D in the fifth embodiment will be described with reference to FIG. 20. FIG. 20 is a flowchart illustrating imaging processing in the fifth embodiment. In the operation of the imaging system 1D in the fifth embodiment, step S1 is omitted from and steps S31 and S32 are added to the operation of the imaging system 1C in the fourth embodiment.

In the imaging system 1D according to the fifth embodiment, instead of measuring the subject distance in advance, the subject distance detector 81 measures the first subject distance D1 when the optical axis is on the first optical axis 23ad which is the initial position.

After the change of the optical axis in step S3, in step S31, the controller 15D determines whether the optical axis is on the first optical axis 23ad which is the initial position. When the controller 15D determines that the optical axis is on the first optical axis 23ad (Yes in step S31), in step S32, the subject distance detector 81 detects the first subject distance D1, and the controller 15D sets this detection value as the subject distance on the first optical axis 23ad. As a result, in step S11, the accuracy of the correction assembly swing angle calculated by the correction assembly swing angle calculator 73 can be improved.

When the controller 15D determines that the optical axis is on the second optical axis 23ae (No in step S31), in step S21, the subject distance calculator 77 calculates the second subject distance D2 based on the optical axis change angle Φ, and newly sets the calculated second subject distance D2 as the subject distance to the imaging target. The controller 15D calculates the mirror swing angle α based on the first subject distance D1 before the optical axis change and the optical axis change angle Φ. As a result, in step S11, the accuracy of the correction assembly swing angle calculated by the correction assembly swing angle calculator 73 can be improved.

As described above, the controller 15D causes the subject distance detector 81 to detect the subject distance in the state of the first optical axis 23ad before the change of the optical axis, and does not cause the subject distance detector 81 to detect the subject distance after the optical axis changing assembly 12B changes the optical axis to the state of the second optical axis 23ae. The subject distance detector 81 detects the subject distance when the optical axis is at the initial position. As a result, when the optical axis is changed obliquely upward with respect to the time of imaging the wall surface of the tunnel 5, erroneous detection of the distance can be prevented in a case where a vehicle, such as a trailer, having a high height in an adjacent lane enters the subject distance detection range. Further, in the case of imaging the road surface, erroneous detection of the distance can be prevented in the case where the vehicle in the adjacent lane enters the subject distance detection range by changing the optical axis from the time of imaging the road surface just below. A distance meter is installed on the wall surface on the side of the tunnel 5 above the height of a general vehicle to be able to detect the distance. This makes it possible to prevent the vehicle in the adjacent lane from becoming a cause of erroneous detection at the time when the optical axis is changed downward.

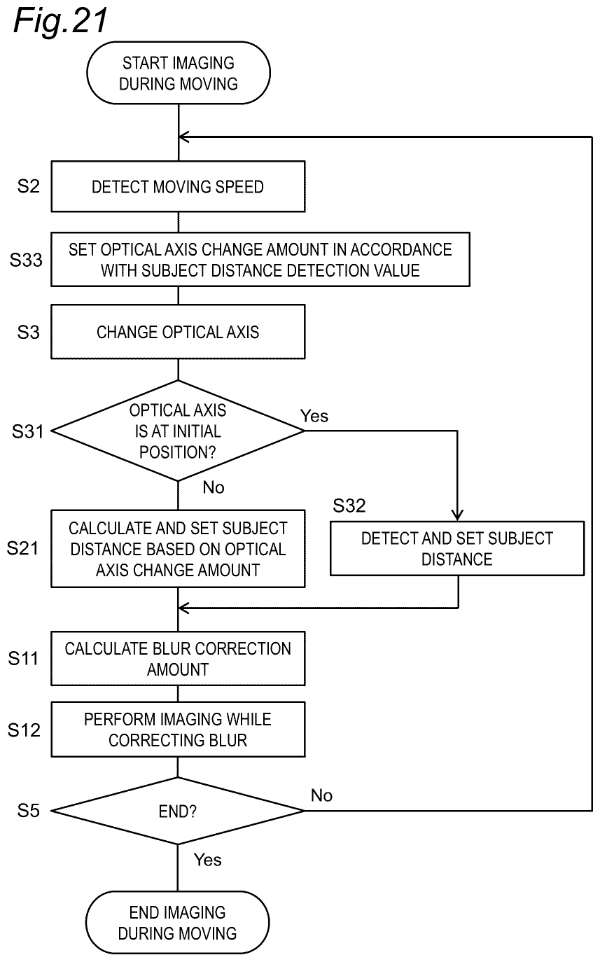

An operation of the imaging system 1D in a modification of the fifth embodiment will be described with reference to FIG. 21. FIG. 21 is a flowchart illustrating imaging processing in the modification of the fifth embodiment. In the operation of the imaging system 1D in the modification of the fifth embodiment, step S33 is added to the operation of the imaging system 1D in the fifth exemplary embodiment.

In step S33, the controller 15D sets the optical axis change angle Φ in accordance with the subject distance detected by the subject distance detector 81. For example, when the subject distance decreases, the detection value in step S32 decreases. Thus, there is no superimposing region of the captured images in the second direction with the same optical axis change amount, and imaging omission might occur. To avoid this, the optical axis change amount is optimally set based on the detected subject distance. Therefore, in step S21, the subject distance at the changed position is calculated based on the set optical axis change amount. This makes it possible to achieve an angle-of-view expansion amount depending on the subject distance.

### Other Embodiments

The above embodiments have been described as the examples of the technique disclosed in this application. However, the technique in the present disclosure is not limited to them, and is applicable to embodiments in which changes, replacements, additions, omissions, etc. are made as appropriate. Therefore, other embodiments will be exemplified below.

In the above embodiments, the information about the moving speed V1 from the speed detector 3a of the vehicle 3 is used, but the present disclosure is not limited thereto. The imaging system 1 may include a speed detector that detects the moving speed of the imaging system 1. The speed detector may use a global positioning system (GPS).

In the above embodiments, the imaging system 1 images the upper and lower wall surfaces of the vehicle 3, but the present disclosure is not limited thereto. The imaging system 1 may image a side wall surface of the vehicle 3.

The above embodiments have described the case where the mobile object is the vehicle 3 such as an automobile. However, the mobile object is not limited to the vehicle 3, and may be a vehicle traveling on the ground such as a train or a motorcycle, a ship traveling on the sea, or a flying object such as an airplane or a drone flying in the air. In a case where the mobile object is a ship, the imaging system 1 images a bottom surface of a bridge pier or bridge girder, or a structure constructed along a coast. In a case where the mobile object is a train, the position and wear of wiring can be detected by imaging the wiring.

In the above embodiments, the image is captured by the light which is ambient light reflected by the imaging target region 9, but the present disclosure is not limited thereto. The imaging target region 9 may be irradiated with light from the mobile object or the imaging system, and an image by reflected light of the irradiated light may be captured.

### Outline of Embodiments

(1) An imaging system of the present disclosure includes an imaging device disposed in a mobile object, an optical axis changing assembly that, when the imaging device performs imaging while the mobile object is moving in a first direction, changes an optical axis of the imaging device to states of k optical axes, k being an integer of two or more, so that the optical axis of the imaging device changes from a state of a first optical axis of the imaging device at a time of capturing a first image to a state of a second optical axis displaced in a second direction intersecting the first direction at a time of capturing a second image, to sequentially change the optical axis of the imaging device in the second direction, and a controller that operates the optical axis changing assembly. The controller operates the optical axis changing assembly between a timing of capturing a first image and a timing of capturing a second image and between a timing of an rth image and a timing of capturing an (r+1)th image after the imaging device captures the rth image satisfying a condition that 2≤r≤n in the total number n of captured images.

As a result, the imaging system can expand the imaging range in the direction intersecting the traveling direction of the mobile object, and can capture an image of the wide range.

(2) In the imaging system of (1), the controller operates the optical axis changing assembly in capturing of the rth image and the (r+1)th image so that the optical axis of the imaging device is fixed during a first time based on a capturing interval of the imaging device between the rth image and the (r+1)th image and an exposure time, and the optical axis of the imaging device is changed at a second time based on the capturing interval and the first time between the timing of capturing the rth image and the timing of capturing the (r+1)th image.

(3) In the imaging system in (2), in the case where r/k is not an integer, the optical axis of the imaging device is changed in the second direction for capturing the (r+1)th image with respect to the time of capturing the rth image, and in the case where r/k is an integer, the optical axis changing assembly changes the optical axis of the imaging device in the third direction opposite to the second direction for capturing the (r+1)th image with respect to the time of capturing the rth image.

(4) In the imaging system in (3), in the case where r/k is an integer, the optical axis changing assembly changes the optical axis of the imaging device to the state of the first optical axis displaced in the third direction at the time of capturing the (r+1)th image with respect to the time of capturing the rth image.

(5) In the imaging system in (4), the captured (r+k)th image is an image acquired by imaging the imaging target region located in the first direction with respect to the imaging target region in the captured rth image, and the end region on the side opposite to the first direction in the captured (r+k)th image overlaps with the end region in the first direction in the captured rth image.

(6) The imaging system in (4) or (5), the imaging system further includes a speed detector that detects a moving speed of the mobile object, and the controller calculates an interval between the capturing of the rth image and the capturing of the (r+k)th image based on the moving speed of the mobile object. This makes it possible to define the capturing interval in the first direction.

(7) In the imaging system in (6), the controller calculates the interval between the capturing of the rth image and the capturing of the (r+1)th image based on the moving speed and the number k of the optical axes. This makes it possible to define the capturing interval in the second direction.

(8) In the imaging system in any one of (2) to (7), in the case where r/k is not an integer, the optical axis change angle through which the optical axis of the imaging device is changed at the time of capturing the (r+1)th image after capturing the rth image is equal to or smaller than an angle of view of the imaging device.

(9) In the imaging system in (3), in the case where r/k is not an integer, the optical axis change angle through which the optical axis of the imaging device is changed at the time of capturing the (r+1)th image with respect to the time of capturing the rth image is equal to or smaller than the angle of view of the imaging device, the captured rth image and the captured (r+k)th image have a common imaging region, and thus the captured rth image, the captured (r+1)th image, and the captured (r+k)th image have the common imaging region.

(10) In the imaging system in any one of (2) to (9), the controller has a first mode in which the imaging device performs imaging while the optical axis changing assembly is being operated between the timing of capturing the first image and the timing of capturing the second image and between the timing of capturing the rth image and the timing of capturing the (r+1)th image, and a second mode in which the imaging device continuously performs imaging without operating the optical axis changing assembly.

(11) The imaging system in any one of (2) to (10) further includes a blur correction assembly that corrects a blur in the first direction when the imaging device performs imaging during movement of the mobile object.

(12) In the imaging system in (11), during the imaging, while the blur correction assembly is being driven, the optical axis changing assembly is in an end state of an optical axis changing operation.

(13) In the imaging system in (11) or (12), by driving the optical axis changing assembly, the optical axis of the blur correction assembly is changed accordingly together with the optical axis of the imaging device.

(14) In the imaging system in any one of (2) to (13), the imaging device is installed with an installation inclination so that the imaging direction is inclined about an axis intersecting the moving direction by a predetermined angle smaller than the optical axis change angle of the optical axis changing assembly, with respect to the imaging target of the imaging device.

(15) In the imaging system in (14), the installation inclination is an angle that is half the optical axis change angle.

(16) In the imaging system in (12) or (13), the controller calculates a subject distance from the imaging device to the imaging target region based on the optical axis change angle changed by the optical axis changing assembly, the subject distance being changed before and after the optical axis changes, and sets a blur correction amount for correcting the blur in the first direction, based on the subject distance.

(17) In the imaging system in (16), the controller calculates the blur correction amount based on the subject distance before the change of the optical axis and the optical axis change angle.

(18) The imaging system in (17) further includes a subject distance measurement device that measures a distance from the imaging device to an imaging target.

(19) In the imaging system in (18), the controller performs the subject distance detection with the subject distance measurement device in the state of the first optical axis before the change of the optical axis, and does not perform the subject distance detection with the subject distance measurement device after the optical axis changing assembly changes the optical axis to the state of the second optical axis.

(20) In the imaging system in (19), the controller sets the optical axis change angle in accordance with the subject distance detected by the subject distance measurement device.

(21) A mobile object includes the imaging system in any one of (1) to (20). This makes it possible for the imaging system to expand the imaging range while the mobile object is moving, and to capture an image of the wide range.

The present disclosure is applicable to an imaging system installed in a moving mobile object.

### EXPLANATIONS OF LETTERS OR NUMERALS

1, 1A, 1B, 1C, 1D Imaging system
3 Vehicle
3a Speed detector
4 Road
4b Hole
4c Crack
5 Tunnel
5a Wall surface
5b Hole
5c Crack
9 Imaging target region
11 Imaging device
12, 12B Optical axis changing assembly
15 Controller
17 Storage
19 Operation unit
21 Camera body
23 Lens
23a Optical axis
23ab, 23ad First optical axis
23ac, 23ae Second optical axis
24 Shutter
25 Imaging element
27 Camera controller
31 Blur correction assembly
41, 41B Mirror
43 Mirror drive
45 Arm
51 Maximum exposure time calculator
61 Base
63 Rotation drive
71 Optical axis change instruction part
73 Correction assembly swing angle calculator
75 Correction assembly rotation speed calculator
81 Subject distance detector
α Mirror swing angle
F Focal length
C1 First state
C2 Second state
M Subject magnification
LE1 Extension line of principal point of lens
LE2 Extension line of imaging target surface
Φ Optical axis change angle
Tf Capturing interval
V1, V2, V3 Moving speed

What is claimed is:

1. An imaging system comprising:
an imaging device disposed in a mobile object;
an optical axis changing assembly that, when the imaging device performs imaging while the mobile object is moving in a first direction, changes an optical axis of the imaging device to states of k optical axes, k being an integer of two or more, so that the optical axis of the imaging device changes from a state of a first optical axis of the imaging device during capturing a first image to a state of a second optical axis displaced in a second direction intersecting the first direction during capturing a second image, to sequentially change the optical axis of the imaging device in the second direction; and
a controller that operates the optical axis changing assembly,
wherein the imaging device is installed with an installation inclination so that a predetermined optical axis among the k optical axes is inclined at a predetermined angle smaller than an optical axis change angle of the optical axis changing assembly with respect to a direction from an installation position of the imaging device to an imaging target region in a plane including the k optical axes.

2. The imaging system according to claim 1,
wherein the installation inclination is an angle that is half the optical axis change angle.

3. The imaging system according to claim 1,
wherein the controller
operates the optical axis changing assembly between a timing of capturing the first image and a timing of capturing the second image, and between a capturing timing of an rth image and a timing of capturing an (r+1)th image after the imaging device captures the rth image satisfying the condition that 2≤r≤n in a total number n of captured images, and
causes, in capturing the rth image and the (r+1)th image, the optical axis changing assembly to fix the optical axis of the imaging device during a first time based on a capturing interval and an exposure time of the imaging device between the rth image and the (r+1)th image and to change the optical axis of the imaging device during a second time based on the capturing interval and the first time between the timing of capturing the rth image and the timing of capturing the (r+1)th image.

4. The imaging system according to claim 3,
wherein the optical axis changing assembly
changes, in a case where r/k is not an integer, the optical axis of the imaging device in the second direction for the capturing of the (r+1)th image with respect to the capturing of the rth image, and
changes, in a case where r/k is an integer, the optical axis of the imaging device in a third direction opposite to the second direction for the capturing of the (r+1)th image with respect to the capturing of the rth image to change the optical axis of the imaging device to the state of the first optical axis.

5. The imaging system according to claim 4,
wherein the optical axis changing assembly changes, in a case where (r+k)/k is an integer, the optical axis of the imaging device to the state of the first optical axis so that an end region on a side opposite to the first direction in an (r+k+1)th captured image overlaps with an end region in the first direction in the (r+1)th captured image, and
wherein the (r+k+1)th captured image is an image obtained by imaging an imaging target region located in the first direction with respect to an imaging target region at the time of capturing the (r+1)th image.

6. The imaging system according to claim 5, further comprising
a speed detector that detects a moving speed of the mobile object,
wherein the controller calculates the capturing interval between the capturing of the rth image and capturing of an (r+k)th image based on the moving speed of the mobile object.

7. The imaging system according to claim 6,
wherein the controller calculates the capturing interval between the rth image and the (r+1)th image based on the moving speed and the number k of the optical axes.

8. The imaging system according to claim 3,
wherein in the case where r/k is not an integer, the optical axis change angle through which the optical axis of the imaging device is changed at the time of capturing the (r+1)th image with respect to the time of capturing the rth image is equal to or smaller than an angle of view of the imaging device.

9. The imaging system according to claim 4,
wherein in the case where r/k is not an integer, the optical axis change angle through which the optical axis of the imaging device is changed at the time of capturing the (r+1)th image with respect to the time of capturing of the rth image is equal to or smaller than an angle of view of the imaging device, the captured rth image and a captured (r+k)th image have a common imaging region, and the captured rth image, the captured (r+1)th image, and the captured (r+k)th image have the common imaging region.

10. The imaging system according to claim 3,
wherein the controller has
a first mode in which the optical axis changing assembly is operated between the timing of capturing the first image and the timing of capturing the second image and between the timing of capturing the rth image and the timing of capturing the (r+1)th image, and the imaging device performs imaging, and
a second mode in which the imaging device performs imaging without operating the optical axis changing assembly.

11. The imaging system according to claim 3, further comprising
a blur correction assembly that corrects a blur in the first direction when the imaging device performs imaging while the mobile object is moving.

12. The imaging system according to claim 11,
wherein while the blur correction assembly is being driven during imaging, the optical axis changing assembly is in a state where an operation for changing the optical axis is ended, and
wherein by driving the optical axis changing assembly, an optical axis of the blur correction assembly is changed together with the optical axis of the imaging device.

13. The imaging system according to claim 11,
wherein the controller calculates a subject distance from the imaging device to the imaging target region based on the optical axis change angle changed by the optical axis changing assembly, the subject distance being changed before and after change of the optical axis, and sets a blur correction amount for correcting the blur in the first direction, based on the subject distance.

14. The imaging system according to claim 13,
wherein the controller calculates the blur correction amount based on the subject distance before the change of the optical axis and the optical axis change angle.

15. The imaging system according to claim 14, further comprising
a subject distance measurement device that measures a distance from the imaging device to an imaging target.

16. The imaging system according to claim 15,
wherein the controller causes the subject distance measurement device to detect the subject distance in the state of the first optical axis before the change of the optical axis, and does not cause the subject distance measurement device to detect the subject distance after the change of the optical axis to the state of the second optical axis with the optical axis changing assembly.

17. The imaging system according to claim 16,
wherein the controller sets the optical axis change angle in accordance with the subject distance detected by the subject distance measurement device.

18. An imaging system comprising:
an imaging device disposed in a mobile object;
an optical axis changing assembly that, when the imaging device performs imaging while the mobile object is moving in a first direction, changes an optical axis of the imaging device to states of k optical axes, k being an integer of two or more, so that the optical axis of the imaging device changes from a state of a first optical axis of the imaging device at a time of capturing a first image to a state of a second optical axis displaced in a second direction intersecting the first direction at a time of capturing a second image, to sequentially change the optical axis of the imaging device in the second direction; and
a controller that operates the optical axis changing assembly,
wherein the controller includes
a first mode in which the optical axis changing assembly is operated between a timing of capturing the first image and a timing of capturing the second image and between a timing of capturing an rth image and a timing of capturing an (r+1)th image, after the imaging device captures the rth image, r satisfying a condition that 2≤r≤n in a total number n of captured images, and the imaging device performs imaging, and
a second mode in which the imaging device performs imaging without operating the optical axis changing assembly.

19. An imaging system comprising:
an imaging device disposed in a mobile object;
an optical axis changing assembly that, when the imaging device performs imaging while the mobile object is moving in a first direction, changes an optical axis of the imaging device to state of k optical axes, k being an integer of two or more, so that the optical axis of the imaging device changes from a state of a first optical axis of the imaging device at a time of capturing a first image to a state of a second optical axis displaced in a second direction intersecting the first direction at a time of capturing a second image, to sequentially change the optical axis of the imaging device in the second direction;
a controller that operates the optical axis changing assembly; and
a blur correction assembly that corrects a blur in the first direction when the imaging device performs imaging while the mobile object is moving,
wherein the controller calculates a subject distance from the imaging device to an imaging target region based on an optical axis change angle changed by the optical axis changing assembly, the subject distance being changed before and after the optical axis changes, and sets a blur correction amount for correcting the blur in the first direction, based on the subject distance.

20. A mobile object comprising the imaging system according to claim 1.
